(19) United States
(12) Patent Application Publication
(10) Pub. No.: US 2026/0296154 A1
(43) Pub. Date: Oct. 1, 2026

(54) PICKUP TRUCK TONNEAU COVER

(71) Applicant: Kunshan Qunguang Automotive Technology Co., Ltd., Suzhou (CN)

(72) Inventor: Shuaiping WANG, Suzhou (CN)

(73) Assignee: Kunshan Qunguang Automotive Technology Co., Ltd., Suzhou (CN)

(21) Appl. No.: 19/531,597

(22) Filed: Feb. 5, 2026

Related U.S. Application Data
(63) Continuation-in-part of application No. 19/340,949, filed on Sep. 26, 2025, now Pat. No. 12,576,702.

(30) Foreign Application Priority Data
Mar. 31, 2025 (CN) 202510389599.0

(51) Int. Cl. B60J 7/19; B60J 7/04; F16B 2/12

(52) U.S. Cl. CPC B60J 7/198; B60J 7/04; F16B 2/12

(57) ABSTRACT

One aspect of the present disclosure relates to a clamping device. The clamping device includes: a first component provided with a first jaw; and a second component provided with a second jaw. The first component and the second component are configured to move toward or away from each other in a first direction, so as to change a distance between the first jaw and the second jaw to achieve clamping. One of the first jaw and the second jaw includes two jaws that are spaced apart from each other in a second direction perpendicular to the first direction, and the other of the first jaw and the second jaw is arranged, in the second direction, between the two jaws. Another aspect of the present disclosure further relates to a pickup truck tonneau cover assembly.

### CROSS-REFERENCE TO RELATED DISCLOSURES

This disclosure is a continuation-in-part of U.S. patent application Ser. No. 19/340,949 filed Sep. 26, 2025, which claims priority to Chinese Patent Application No. 202510389599.0, field on Mar. 31, 2025, the entire disclosure of which is incorporated herein by reference, to the extent permitted by law.

### TECHNICAL FIELD

The present disclosure relates to the technical field of automobile parts, and in particular to a pickup truck tonneau cover.

### BACKGROUND

Pickup trucks are an important part of the automobile market, typically including a passenger cab and an open cargo bed. In order to protect cargo from adverse weather, enhance privacy and security, and improve the overall appearance of the vehicle, the cargo bed is usually covered with a tonneau cover. The primary functions of the tonneau cover include providing water resistance and theft prevention. Common types of tonneau covers include flip-fold type, retractable type, soft roll-up type, and frame type.

Existing flip-fold tonneau covers are typically made of multiple panels connected by hinge shafts. In some use scenarios, a user needs to flip the plates sequentially to fold or unfold the rear cover, so as to open or close the rear cover, and this process may be inconvenient to operate and time-consuming and laborious. In some vehicle operating conditions (e.g., high-speed driving or strong vibration), the installation stability may be insufficient, which may lead to a risk of loosening or even falling off of components. In some cases, leakage may occur due to insufficient waterproof performance. In addition, some solutions may be difficult to realize motorized or intelligent operation, while motorization and intelligence have attracted attention in some disclosures.

### SUMMARY

In some embodiments, the present disclosure provides a pickup truck tonneau cover, which, in some configurations, may improve installation stability, operation convenience, and/or performance such as waterproof and anti-theft performance.

One aspect of the present disclosure relates to a clamping device.

According to some exemplary embodiments, the clamping device includes a first component provided with a first jaw and a second component provided with a second jaw; the first component and the second component are configured to move toward or away from each other in a first direction to change a distance between the first jaw and the second jaw to achieve clamping; and one of the first jaw and the second jaw includes two jaws spaced apart from each other in a second direction perpendicular to the first direction, and the other of the first jaw and the second jaw is arranged, in the second direction, between the two jaws.

According to some exemplary embodiments, one of the two jaws is a fixed jaw and the other of the two jaws is an adjustable jaw, and the adjustable jaw is arranged in a sliding slot extending along the second direction, such that a position of the adjustable jaw in the second direction relative to the fixed jaw is changeable.

According to another exemplary embodiment, the first component has a base portion extending along the first direction and a first extension portion extending in the second direction, and the base portion is provided with a slide rail extending along the first direction, and the second component is configured to move along the slide rail.

According to some exemplary embodiments, the clamping device further includes a first fastening bolt extending along the first direction and having a first part passing through the first extension portion of the first component and a second part passing through the second component, and the second part of the fastening bolt is in threaded engagement with the second component.

According to some exemplary embodiments, the second component has, in the second direction, an upper part located above the slide rail and a lower part located below the slide rail, and the lower part extends below the base portion and abuts against a lower surface of the base portion.

According to some exemplary embodiments, the first component further includes a second extension portion extending from the base portion toward a direction opposite to an extending direction of the first extension portion, and an end of the second extension portion has a bent portion; and the clamping device further includes a second fastening bolt in threaded engagement with the bent portion, and one end of the second fastening bolt is configured to abut against the lower part of the second component.

According to some preferred embodiments, one of the two jaws is a fixed jaw and the other of the two jaws is an adjustable jaw, and the adjustable jaw is arranged in a sliding slot extending along the second direction, such that a position of the adjustable jaw in the second direction relative to the fixed jaw is changeable; the first component has a base portion extending along the first direction and a first extension portion extending in the second direction, and the base portion is provided with a slide rail extending along the first direction, and the second component is configured to move along the slide rail; the clamping device further includes a first fastening bolt extending along the first direction and having a first part passing through the first extension portion of the first component and a second part passing through the second component, and the second part of the fastening bolt is in threaded engagement with the second component; the second component has, in the second direction, an upper part located above the slide rail and a lower part located below the slide rail, and the lower part extends below the base portion and abuts against a lower surface of the base portion; the first component further includes a second extension portion extending from the base portion toward a direction opposite to an extending direction of the first extension portion, and an end of the second extension portion has a bent portion; and the clamping device further includes a second fastening bolt in threaded engagement with the bent portion, and one end of the second fastening bolt is configured to abut against the lower part of the second component.

Another aspect of the present disclosure relates to a pickup truck tonneau cover assembly.

According to some exemplary embodiments, the pickup truck tonneau cover assembly includes a tonneau cover and the clamping device of any one of the foregoing embodiments for fixing the tonneau cover to a truck bed of a pickup truck. The truck bed has two side frames respectively located on two sides of the truck bed, and the tonneau cover includes two mounting frames respectively mounted on the two side frames, and each side frame has a second wall abutting against a first wall of a corresponding one of the two mounting frames; and the first wall and the second wall are clamped and fixed, in the first direction, between the first jaw and the second jaw of the clamping device.

According to some exemplary embodiments, the pickup truck tonneau cover assembly further includes a tightening apparatus abutting between the two mounting frames, wherein the tightening apparatus is arranged adjacent to a cab of the pickup truck.

According to some exemplary embodiments, the pickup truck tonneau cover assembly further includes a mounting plate mounted to a front wall of the truck bed or a rear wall of a cab, wherein two ends of the mounting plate are respectively provided with tightening bolts, and one end of each tightening bolt abuts against a corresponding one of the mounting frames.

According to some exemplary embodiments, two ends of the mounting plate are respectively provided with first positioning structures, and an end portion of each mounting frame corresponding to the mounting plate is provided with a second positioning structure corresponding to the first positioning structure.

According to some exemplary embodiments, the tonneau cover includes: a foldable scissor mechanism arranged in the mounting frame and formed by a plurality of connecting rods connected in sequence; a plurality of cover plates; and a plurality of mounting arms, each mounting arm being configured to connect a corresponding one of the plurality of cover plates to a corresponding one of the plurality of connecting rods. The pickup truck tonneau cover assembly further includes at least one locking structure configured to lock any one of the plurality of connecting rods, the plurality of mounting arms, and the plurality of cover plates at a predetermined angle or position.

According to some exemplary embodiments, the mounting frame is provided therein with a slideway, upper end portions of adjacent connecting rods among the plurality of connecting rods of the scissor mechanism are connected via an upper hinge shaft, and the upper hinge shaft is configured to slide in the slideway.

According to some exemplary embodiments, each mounting frame further includes a horizontal plate-like member at an upper end thereof, and the horizontal plate-like member presses on an upper end surface of the side frame of the truck bed.

According to some exemplary embodiments, an upper end of each mounting frame is provided with an inverted U-shaped plate-like member sleeved on an upper end of the side frame.

### BRIEF DESCRIPTION OF THE DRAWINGS

FIG. 1 is a schematic structural diagram of a pickup truck tonneau cover according to an embodiment of the present disclosure.

FIG. 2 is a schematic diagram of an installation of the mounting frame of the pickup truck tonneau cover according to an embodiment of the present disclosure.

FIG. 3 is a schematic diagram of a scissor mechanism of the pickup truck tonneau cover in an unfolded state according to an embodiment of the present disclosure.

FIG. 4 is a schematic diagram of the scissor mechanism of the pickup truck tonneau cover in a folded state according to an embodiment of the present disclosure.

FIG. 5 is a schematic diagram of an installation of the lifting and rotating bracket of the pickup truck tonneau cover according to an embodiment of the present disclosure.

FIG. 6 is a schematic diagram of the scissor mechanism of the pickup truck tonneau cover in a folded state according to an embodiment of the present disclosure.

FIG. 7 is a schematic diagram of a three-dimensional structure of the scissor mechanism of the pickup truck tonneau cover in a folded state according to an embodiment of the present disclosure.

FIG. 8 is a schematic diagram of an installation of the lifting and rotating bracket of the pickup truck tonneau cover according to an embodiment of the present disclosure.

FIG. 9 is a schematic diagram of a scissor mechanism of the pickup truck tonneau cover in an unfolded state according to an embodiment of the present disclosure.

FIG. 10 is a schematic diagram of the scissor mechanism of the pickup truck tonneau cover in a folded state according to an embodiment of the present disclosure.

FIG. 11 is a schematic diagram of a scissor mechanism of the pickup truck tonneau cover in an unfolded state according to an embodiment of the present disclosure.

FIG. 12 is a schematic diagram of the scissor mechanism of the pickup truck tonneau cover in a folded state according to an embodiment of the present disclosure.

FIG. 13 is a schematic diagram of the scissor mechanism of the pickup truck tonneau cover in a folded state according to an embodiment of the present disclosure.

FIG. 14 is a schematic diagram of the scissor mechanism of the pickup truck tonneau cover in a folded state according to an embodiment of the present disclosure.

FIG. 15 is a schematic structural diagram of a pickup truck tonneau cover according to an embodiment of the present disclosure.

FIG. 16 is a schematic diagram of a scissor mechanism of the pickup truck tonneau cover in an unfolded state according to an embodiment of the present disclosure.

FIG. 17 is a schematic diagram of the scissor mechanism of the pickup truck tonneau cover in a folded state according to an embodiment of the present disclosure.

FIG. 18 is a schematic diagram of the installation of a cover plate of the pickup truck tonneau cover according to an embodiment of the present disclosure.

FIG. 19 is a schematic diagram of the scissor mechanism of the pickup truck tonneau cover in a folded state according to an embodiment of the present disclosure.

FIG. 20 is a schematic structural diagram of a pickup truck tonneau cover according to an embodiment of the present disclosure.

FIG. 21 is a schematic diagram of a scissor mechanism of the pickup truck tonneau cover in an unfolded state according to an embodiment of the present disclosure.

FIG. 22 is a schematic structural diagram of a waterproof plate of a pickup truck tonneau cover according to an embodiment of the present disclosure.

FIG. 23 is a schematic diagram of the scissor mechanism of the pickup truck tonneau cover in a folded state according to an embodiment of the present disclosure.

FIG. 24 is an enlarged view of point A in FIG. 5.

FIG. 25 is an enlarged view of point B in FIG. 8.

FIG. 26 is an enlarged view of point C in FIG. 6.

FIG. 27 is an enlarged view of point D in FIG. 14.

FIG. 28 is a schematic diagram of an intelligent control system of the pickup truck tonneau cover.

FIGS. 29 and 30 are schematic structural diagrams of a clamping device for installing a tonneau cover to a side wall of a truck bed of a pickup truck according to an exemplary embodiment of the present disclosure.

FIG. 31 is a schematic diagram of installing a tonneau cover to a side wall of a truck bed by using the clamping device of FIG. 29 according to an exemplary embodiment of the present disclosure, wherein a mounting frame of the tonneau cover is arranged at an inner side of the side wall of the truck bed, and the mounting frame has a horizontal plate-like member pressing on an upper end surface of a side frame of the truck bed.

FIG. 32 is a schematic diagram of an installation of a mounting frame of a tonneau cover according to another exemplary embodiment of the present disclosure, wherein the mounting frame has an inverted U-shaped plate-like member sleeved on an upper end of a side frame of a truck bed.

FIG. 33 is a schematic diagram of installing a tonneau cover to a side wall of a truck bed by using the clamping device of FIG. 29 according to another exemplary embodiment of the present disclosure, wherein a mounting frame of the tonneau cover is arranged on an upper side of the side wall of the truck bed.

FIG. 34 is a schematic diagram of an installation of a tonneau cover assembly according to another exemplary embodiment of the present disclosure.

FIG. 35 is a schematic diagram of an installation of a tonneau cover assembly according to yet another exemplary embodiment of the present disclosure.

In the drawings:
1. cover plate; 11. first cover plate; 12. first lapping part; 13. seal; 14. second lapping part;
2. folding apparatus; 20. mounting frame; 21. folding mechanism; 22. upper hinge shaft; 23. lower hinge shaft; 24. gear;
210. intersecting rod assembly; 2101. first support rod; 2102. second support rod; 2103. third support rod; 2104. fourth support rod; 2105. fifth support rod; 2106. sixth support rod; 2202. support rod;
211. first intersecting rod assembly; 212. second intersecting rod assembly;
250. control unit; 251. drive device; 252. sensor unit; 253. communication unit;
31. side wall; 32. front wall;
4. mounting arm; 41. first mounting arm; 42. second mounting arm; 43. ear plate; 44. bent part;
5. slideway;
6. lifting and rotating bracket; 61. first connecting rod; 62. second connecting rod; 63. drive connecting rod; 64. linkage connecting rod;
601. first pivot; 602. second pivot; 603. third pivot; 604. fourth pivot; 605. fifth pivot; 606. sixth pivot;
7. sliding slot;
8. waterproof plate; 81. avoidance groove; 82. waterproof cover;
9. drive bracket; 91. first drive rod; 92. second drive rod;
100. cab; 101. tailgate.
300. clamping device; 301. second jaw; 302. first fixed jaw; 303. first adjustable jaw; 304. first operating portion; 305. hole; 306. sliding slot; 307. base body; 308. base portion; 309. second extension portion; 310. bent portion; 311. second operating portion; 312. second fastening bolt; 313. lower part; 314. slide rail; 315. fastening nut; 316. movable body; 317. upper part; 318. first fastening bolt; 319. first extension portion;
400. side frame; 401. side frame side wall;
500. tonneau cover; 501. mounting frame; 502. mounting frame side wall;
503. horizontal plate-like member; 503′. inverted U-shaped plate-like member; 504. flexible material layer; 510. tightening apparatus; 520. mounting plate; 521. lug; 522. tightening bolt; 523. third operating portion; 524. bent plate; 525. groove; 600. fixing plate; 610. spring lock; 620. handle.

### BRIEF DESCRIPTION OF THE DRAWINGS

In order to better explain the present disclosure and facilitate understanding, the present disclosure is described in detail below with reference to the accompanying drawings and specific embodiments. The directional terms “upper”, “lower”, etc. mentioned herein are based on the orientation of FIG. 1.

Although exemplary embodiments of the present disclosure are shown in the accompanying drawings, it should be understood that the present disclosure can be implemented in various forms and should not be limited by the embodiments set forth herein. Instead, these embodiments are provided to enable a clearer and more thorough understanding of the present disclosure and to fully convey the scope of the present disclosure to those skilled in the art.

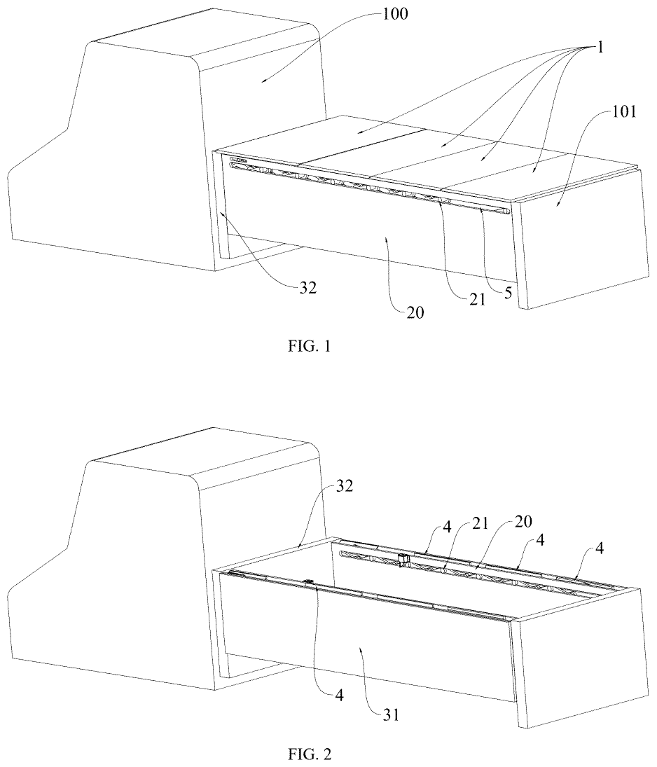

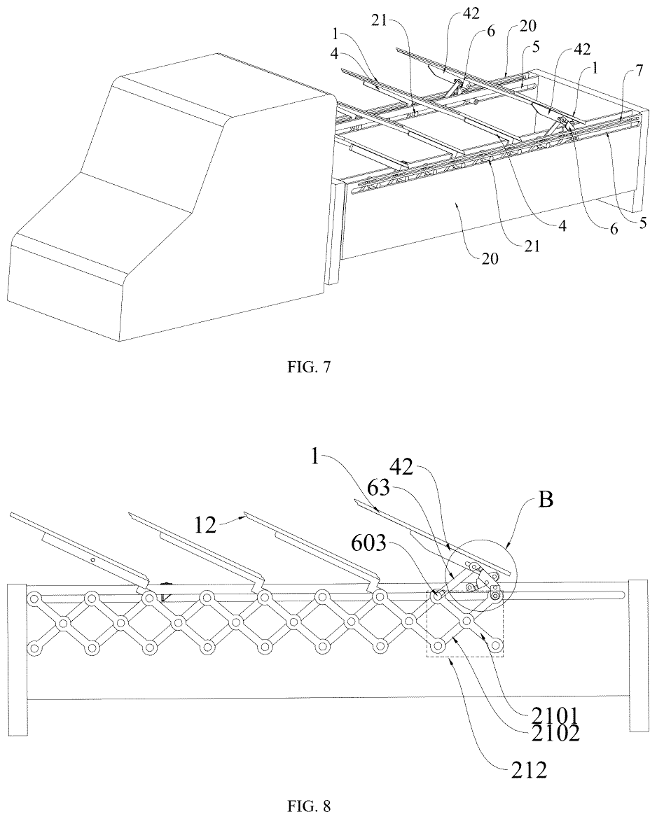

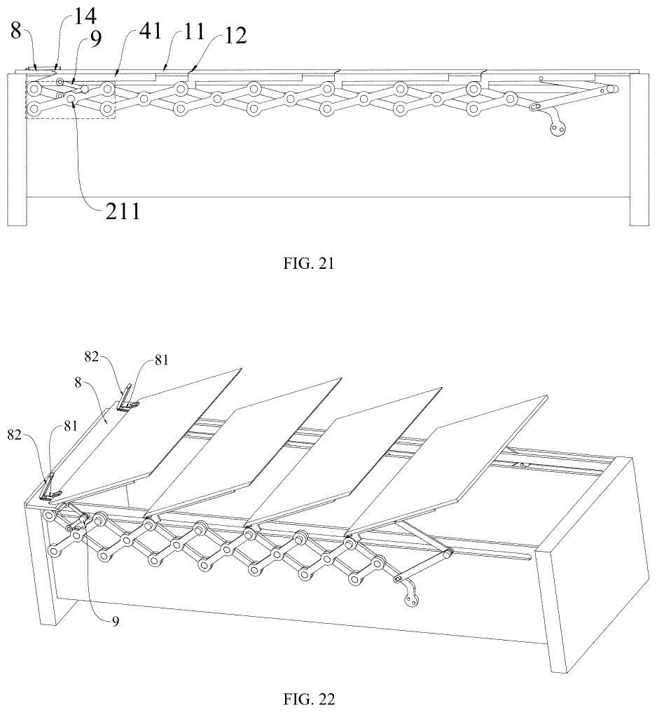

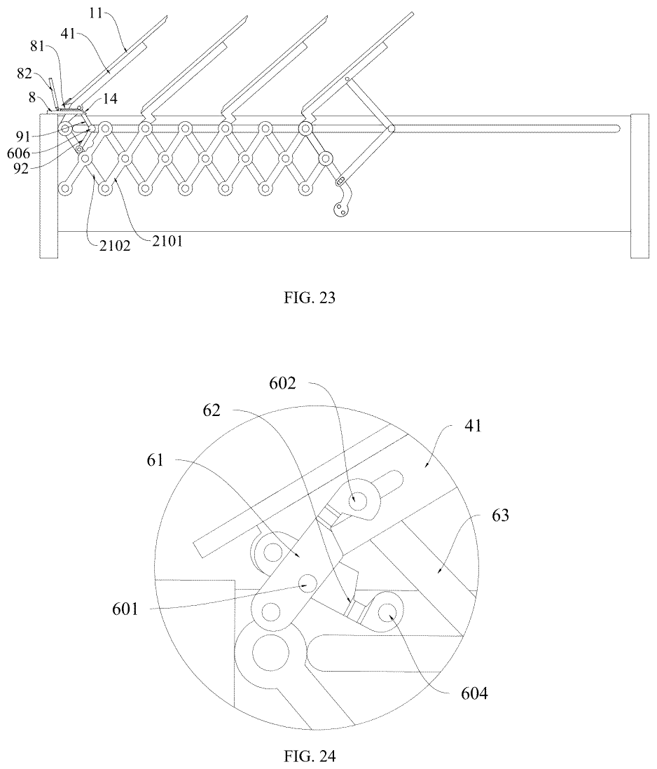

As shown in FIG. 1 to FIG. 23, the present disclosure provides a pickup truck tonneau cover, which includes one or more cover plates 1 and a pair of relatively arranged folding apparatuses 2. The pair of folding apparatuses 2 are detachably connected to the two inner side surfaces of the pickup truck's truck bed, and the folding apparatuses 2 adopt a modular design to facilitate the transportation and disassembly of the pickup truck tonneau cover. The folding apparatus 2 includes a mounting frame 20 and a folding mechanism 21. The mounting frame 20 is provided at the inner side surface of the truck bed through the mounting mechanism, and the folding mechanism 21 is provided inside the mounting frame 20. In an embodiment, the pickup truck tonneau cover further includes a mounting apparatus and a tightening apparatus. The mounting apparatus includes a clamping apparatus, which can reliably clamp the mounting frame 20 to the side wall of the truck bed, thereby fixing the mounting frame 20 to the side frame of the truck bed, which not only ensures the stability of the mounting frame but also facilitates the rapid installation and removal of the tonneau cover. The tightening apparatus is provided at the front of the truck bed, and the two ends of the tightening apparatus are detachably connected to the first ends of the pair of mounting frames 20 adjacent to the cab, respectively. The tightening apparatus can not only further improve the stability of the mounting frame 20 during use, but also improve the convenience of disassembly and assembly of the entire pickup truck tonneau cover.

The folding mechanism 21 can be implemented in a variety of ways, such as a folding connecting rod assembly including multiple connecting rods connected in sequence or their deformations, such as multiple X-shaped fork rods hinged in sequence, multiple X-shaped fork rods partially overlapping and hinged, etc. According to an exemplary embodiment of the present disclosure, the folding mechanism 21 includes a scissor mechanism. In an embodiment of the present disclosure, a plurality of mounting arms 4 are provided on the scissor mechanism, and the mounting arms 4 extend from the top surface of the mounting frame 20. One end of the cover plate 1 is respectively mounted to the corresponding mounting arm 4 on a scissor mechanism, and another end of the same cover plate 1 is respectively mounted to the corresponding mounting arm 4 on another scissor mechanism, so that each cover plate 1 is connected to a pair of corresponding mounting arms 4.

In an embodiment, the top surface height of the mounting frame 20 is lower than or flush with the top surface height of the side wall of the truck bed, so that the center of gravity of the folding apparatus 2 can be lowered and the stability of the vehicle operation can be improved. In addition, by providing the scissor mechanism in the mounting frame 20, the mounting frame 20 can protect the scissor mechanism and prevent items in the truck bed from entering the interior of the scissor mechanism. The scissor mechanism telescopes along the length of the truck bed. This motion can be driven manually or electrically. Manually, one cover plate 1, such as the cover plate 1 at the tailgate 101, can be flipped, thereby causing the other covers 1 to flip synchronously through the scissor mechanism. Alternatively, a motor can be provided to indirectly drive the scissor mechanism through a transmission mechanism such as a lead screw, rocker, cable, or worm gear, multiple drive methods may be adopted. During telescopic operation, the scissor mechanism remains within the mounting frame 20, preventing it from extending beyond the mounting frame 20 and the truck bed, reducing the risk of damage, which also improves the stability of the scissor mechanism's installation and prevents it from falling off during high-speed driving. As the scissor mechanism switches between folded and unfolded positions, the mounting arms 4 move with the scissor mechanism, extending above the mounting frame 20 and the truck bed to prevent interference between the scissor mechanism and the cover plates 1, and interference between the cover plates 1 and the left and right side frames of the truck bed. Multiple mounting arms 4 simultaneously rotate and move laterally in the same direction, driving the rotation and lateral movement of the cover plates 1. In an embodiment, the pickup truck tonneau cover may further include one or more locking mechanisms, which can lock the unfolded state or folded state of the folding bracket, thereby preventing the folding bracket from accidentally switching when the vehicle is moving or under the action of external forces, further improving the safety and reliability of the tonneau cover.

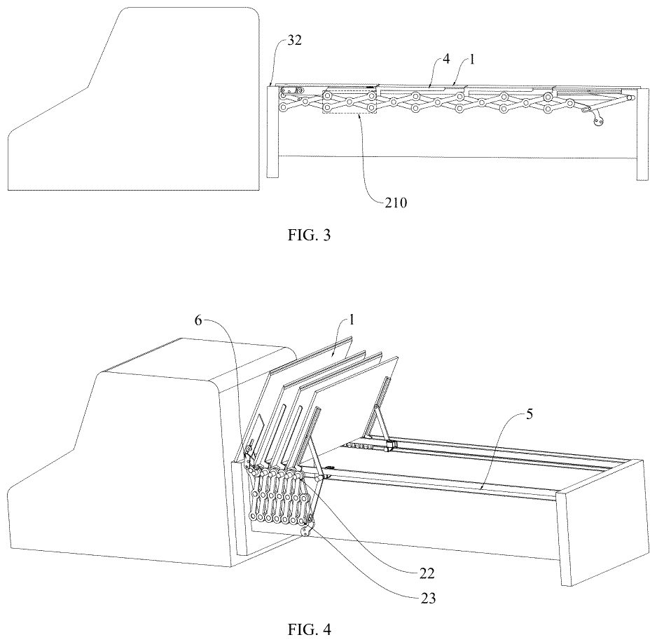

In some embodiments, as shown in FIG. 3, when the scissor mechanism is in the unfolded state, the mounting arm 4 is in the shape of a straight rod, with its upper end surface flush with the top surface of the truck bed. The lower surface of the cover plate is mounted to the upper end surface of the mounting arm, thereby providing multiple cover plates 1 in a horizontal state and overlapping in sequence to form a flat plate. In other embodiments not shown, the mounting arm may also have other shapes, as long as the cover plates can be provided in a horizontal state when the folding mechanism is unfolded. In an embodiment, as shown in FIG. 1, FIG. 15, or FIG. 20, the area of the flat plate is larger than the area of the truck bed top opening, and the flat plate completely covers the truck bed top opening. For example, the length of the cover plate along the width of the vehicle body can be set to be greater than the distance between the two side walls of the truck bed. Furthermore, the top surface of the truck bed side wall 31 abuts the bottom surface of the flat plate, thereby sealing the truck bed and effectively improving the dust and water resistance of the truck bed. In an embodiment, a waterproof pad, such as a rubber pad, is provided at the abutment between the top surface of the truck bed side wall and the bottom surface of the cover plate. For example, the rubber pad can be provided on the bottom surface of the cover plate in the form of a strip extending along the entire length of the cover plate at a position corresponding to the top surface of the side wall of the truck bed. When the scissor mechanism is in the folded state, the plurality of mounting arms 4 are all tilted and retracted to the front of the truck bed adjacent to the cab 100, thereby causing the plurality of cover plates 1 to be tilted and retracted to the front of the truck bed adjacent to the cab 100. The truck bed is in an open state, thereby increasing the opening area of the truck bed, making it easier to take items, and improving the space utilization of the truck bed.

Since the cover plates need to rotate simultaneously during the linear motion toward the front or tailgate during the folding process of the scissor mechanism, there is a situation where the ends of adjacent cover plates abut against each other and interfere with each other, affecting the rotation of the cover plates. In some solutions, a gap may be provided between adjacent cover plates to mitigate the related impact. Then, in some use situations, such an arrangement may reduce waterproof sealing performance between adjacent cover plates. The present disclosure adopts a mutually overlapping connection form between the cover plates 1, thereby effectively avoiding the problem of mutual interference between the cover plates 1 when they rotate from a flat state, and the overlapping parts and the provision of seals 13 on the overlapping parts improve the waterproof and dustproof effects between the cover plates 1. The relevant specific structure will be further described in detail in the following specific embodiments.

The mounting frame 20 can be a box-shaped structure, and the inner side and bottom side of the mounting frame 20 facing the truck bed side frame are basically completely closed. The slideway 5 for facilitating the movement of the folding mechanism 21 is provided inside the mounting frame 20, and a strip groove for the mounting arm 4 to extend is provided on the top side, which has the effect of preventing dust and water, and improving the durability of the scissor mechanism.

To avoid ambiguity, the terms “horizontal state” and “non-horizontal state” as used in the present disclosure are relative concepts, both defined with reference to a reference plane formed by the upper surface of the truck bed, which may be understood as the geometric plane defined by the connecting line of the upper edges of the two opposite side walls of the truck bed and its extended surface, rather than by the ground or gravity direction. The term “horizontal state” refers to a state in which the cover plate is parallel or substantially parallel to the reference plane. In this state, the folding mechanism is in an unfolded state, and the plurality of cover plates continuously cover the opening of the truck bed. Minor angular deviations resulting from manufacturing and assembly tolerances, material compression deformation, applied loads, or thermal expansion and contraction are still regarded as “substantially parallel” and fall within the scope of the “horizontal state.” Correspondingly, the term “non-horizontal state” refers to any orientation of the cover plate that is not parallel to the reference plane, encompassing all intermediate postures during the transition of the folding mechanism from the fully unfolded state to the folded state and vice versa. These include, but are not limited to, various inclined angles, near-vertical or vertical orientations, partially lifted states, or segmental flipping states. During this process, the cover plates may individually or simultaneously change their orientation relative to the reference plane, and their angles may continuously vary with the telescopic movement of the folding mechanism. In some embodiments of the present disclosure, terms such as “tilted,” “vertical,” “forward tilted,” or “rearward tiled” may be used for ease of description; however, these are merely exemplary descriptions of the “non-horizontal state” and do not limit the range of cover plate orientations. Meanwhile, the expressions “horizontal/non-horizontal” are only intended to define the posture of the cover plates, and do not limit the specific structural form or movement trajectory of the folding mechanism, the mounting arms, or the truck bed.

The present disclosure is described in detail below in combination with multiple embodiments.

As shown in FIG. 1 to FIG. 5, for ease of description and reference, it is defined that the tilted state in which the rear end of the cover plate 1 is rotated upward in FIG. 4 as the rearward tilted state of the cover plate 1. The scissor mechanism includes a plurality of intersecting rod assemblies 210 connected in sequence along the length of the truck bed. Among the plurality of intersecting rod assemblies 210, the intersecting rod assembly 210 located at the front end of the scissor mechanism adjacent to the cab 100 is designated as the first intersecting rod assembly 211. The lifting and rotating bracket 6 is installed at the front of the truck bed adjacent to the cab 100. When the existing pickup truck is modified, when the pickup truck tonneau cover is installed, the bottom surface of the cover plate 1 located closest to the front wall 32 of the truck bed abuts against the top surface of the front wall 32 of the truck bed. When the cover plate is opened only by rotation, the bottom surface of the cover plate 1 and the top surface of the front wall 32 interfere with each other, making it impossible to open normally. Therefore, the mounting arm 4 of the present disclosure is connected to the first intersecting rod assembly 211 through the lifting and rotating bracket 6. Under the action of the first intersecting rod assembly 211, the mounting arm 4 rotates and lifts, thereby ensuring that the cover plate 1 closest to the front wall 32 of the truck bed passes over the front wall 32 of the truck bed during the lifting process, avoiding the situation where the cover plate 1 interferes with the front wall 32 of the truck bed when rotating due to the overlapping area of the cover plate 1 being larger than the area of the top opening of the truck bed.

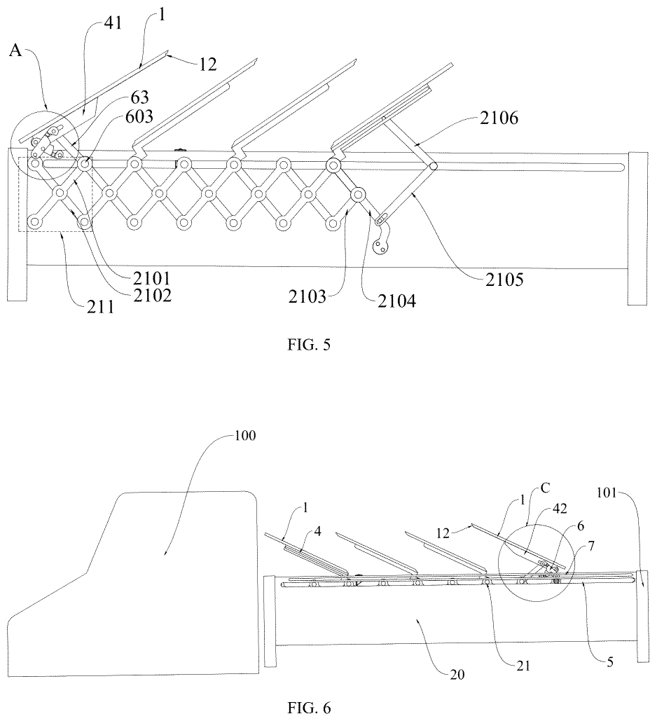

Furthermore, the upper end of one of the support rods of the first intersecting rod assembly 211 is hinged to the mounting frame 20, and the hinge point is located on the extension line of the slideway 5 toward the cab 100. Each intersecting rod assembly 210 includes a first support rod 2101 and a second support rod 2102, each hinged to each other. The hinge point of the first support rod 2101 and second support rod 2102 can be located at the center of the rod body. In adjacent intersecting rod assemblies 210, the first support rod 2101 of one intersecting rod assembly 210 is connected to the second support rod 2102 of the other intersecting rod assembly 210 via an upper hinge shaft 22, while the second support rod 2102 of one intersecting rod assembly 210 is connected to the first support rod 2101 of the other intersecting rod assembly 210 via a lower hinge shaft 23. The mounting frame 20 is provided with a slideway 5 extending along the length of the truck bed. The upper hinge shaft 22 is slidably connected to the slideway 5, providing guidance and limiting for the folding movement of the scissor mechanism. The first intersecting rod assembly 211 is connected to the corresponding first mounting arm 41 of the multiple mounting arms 4 via a lifting and rotating bracket 6. When the scissor mechanism is folded, the pair of support rods of the first intersecting rod assembly 211 pivot relative to each other, and the pair of support rods of the first intersecting rod assembly 211 drive the first mounting arm 41 to rotate and lift or lower the first mounting arm 41 by driving the lifting rotating bracket 6. The other mounting arms 4 except the first mounting arm 41 are directly connected to the first support rod 2101 of the corresponding intersecting rod assembly 210 for mounting the cover plate 1. It should be noted that in some embodiments, the intersecting rod assembly and the mounting arm may be in a one-to-one correspondence, that is, each intersecting rod assembly may be provided with a mounting arm. In other embodiments, the intersecting rod assembly and the mounting arm may not be in a one-to-one correspondence. For example, a mounting arm may be provided for every other intersecting rod assembly, as shown in FIG. 4 and FIG. 5. A mounting arm may also be provided for every two intersecting rod assemblies, and those skilled in the art may set it according to the size of the intersecting rod assembly and the size of the cover plate.

The mounting arm 4 is connected to the first intersecting rod assembly 211 via a lifting and rotating bracket 6. Under the action of the first intersecting rod assembly 211, it rotates and lifts, thereby ensuring that the cover plate 1 closest to the front wall 32 of the truck bed passes over the front wall 32 during the lifting process. This prevents the cover plate 1 from interfering with the front wall 32 of the truck bed during rotation due to the overlapping area of the cover plate 1 being larger than the area of the truck bed top opening.

As shown in FIG. 4 and FIG. 5, except for the mounting arm provided on the first intersecting rod assembly 211, the other mounting arms 4 are connected to the upper end of the first support rod 2101 at the same position on the corresponding intersecting rod assembly. The mounting frame 20 can be box-shaped, with the inner side and bottom side of the mounting frame 20 facing the truck bed side frame being substantially completely enclosed. A slideway 5 facilitating the movement of the scissor mechanism is located within the mounting frame 20. A strip groove is provided on the top side for the mounting arm 4 to extend, providing dust and water resistance and improving the durability of the scissor mechanism. As shown in FIG. 5, the scissor mechanism further includes an auxiliary support frame, which further enhances the stability of the scissor mechanism when the cover is open. Specifically, the auxiliary support frame includes a third support rod 2103, a fourth support rod 2104, a fifth support rod 2105, and a sixth support rod 2106. One end of the third support rod 2103 is hinged to the lower end of the second support rod 2102 in the second intersecting rod assembly 212. The second end of the third support rod 2103 is hinged to the center of the fourth support rod 2104. The first end of the fourth support rod 2104 is hinged to the upper end of the first support rod 2101 in the second intersecting rod assembly 212. The first end of the sixth support rod 2106 is hinged to the rightmost mounting arm 4. The second end of the fourth support rod 2104 is connected to the waist-shaped hole at the first end of the fifth support rod 2105 via a rotating shaft. The second ends of the fifth and sixth support rods 2105 and 2106 are hinged and then slidably connected to the slideway 5.

As shown in FIG. 24, the lifting and rotating bracket 6 includes a first connecting rod 61, a second connecting rod 62, and a drive connecting rod 63. The first connecting rod 61 and the second connecting rod 62 are hinged via a first pivot 601. The first pivot 601 is offset from the center point of the first connecting rod 61 and is located adjacent to the first end of the first connecting rod 61 (the end facing the cab in FIG. 24). The first pivot 601 is offset from the center point of the second connecting rod 62 and is located adjacent to the first end of the second connecting rod 62 (the end facing the cab in FIG. 24). The first end of the second connecting rod 62 is hinged to the first mounting arm 41. The first end of the drive connecting rod 63 is hinged to the second end of the first connecting rod 61 via a second pivot 602. The second pivot 602 is configured to be slidable relative to the first mounting arm 41, or the drive connecting rod 63 is directly hinged to the first mounting arm 41. The second end of the drive connecting rod 63 is slidably connected to the slideway 5 via a hinged third pivot 603, driving the second end of the drive connecting rod 63 to move along the slideway 5 during movement of the scissor mechanism. In an embodiment, the second end of the drive connecting rod 63 is hinged to the upper end of the second support rod 2102 in the first intersecting rod assembly 211. During movement of the scissor mechanism, the distance between the upper ends of the two support rods in the first intersecting rod assembly 211 changes, driving the second end of the drive connecting rod 63 to move along the slideway 5, thereby rotating the first mounting arm 41 connected to the drive connecting rod 63. The first end of the first connecting rod 61 is hinged to the mounting frame 20, and the second end of the second connecting rod 62 is slidably connected to the mounting frame 20 via a hinged fourth pivot 604. The connection between the first connecting rod 61 and the second connecting rod 62 on the mounting frame 20 is located above the slideway 5. The first connecting rod 61 and the second connecting rod 62 are linked by a hinge point, allowing the first mounting arm 41 to simultaneously rotate about the hinge point and lift, preventing the protruding edge of the cover plate 1 from interfering with the front wall 32 of the truck bed during rotation. The closing process is the reverse of the opening process, thus similarly avoiding interference during closing.

As shown in FIG. 6 to FIG. 8, the scissor mechanism of this embodiment is similar in structure to that of the above embodiment, but the auxiliary support frame is eliminated. For ease of description, it is defined that the tilted state in which the front end of the cover plate 1 in FIG. 6 is rotated upward as the forward tilted state of the cover plate 1. The lifting and rotating bracket 6 is installed at the rear of the truck bed adjacent to the tailgate 101. Among the multiple intersecting rod assemblies 210, the intersecting rod assembly 210 located at the rear end of the scissor mechanism adjacent to the tailgate 101 is defined as the second intersecting rod assembly 212. The upper ends of the two support rods of the second intersecting rod assembly 212 are both slidably connected to the slideway 5 on the mounting frame 20. The second intersecting rod assembly 212 is connected to the corresponding second mounting arm 42 of the multiple mounting arms 4 via a lifting and rotating bracket 6.

When the scissor mechanism is folded, the pair of support rods of the second intersecting rod assembly 212 pivot relative to each other. The pair of support rods of the second intersecting rod assembly 212 drives the lifting and rotating bracket 6 to rotate and lift or lower the second mounting arm 42. Simultaneously, the lifting and rotating bracket 6, driven by the second intersecting rod assembly 212, slides along the slideway 5 toward the front of the truck bed along with the second intersecting rod assembly 212. All mounting arms 4, except the second mounting arm 42, are connected to one of a pair of support rods of the corresponding intersecting rod assembly 210. The second mounting arm 42 rotates and rises under the action of the second intersecting rod assembly 212 and the lifting and rotating bracket 6 to prevent the cover plate 1 from interfering with the two side walls and rear of the truck bed during rotation due to the cover plate 1 being larger than the truck bed after being overlapped.

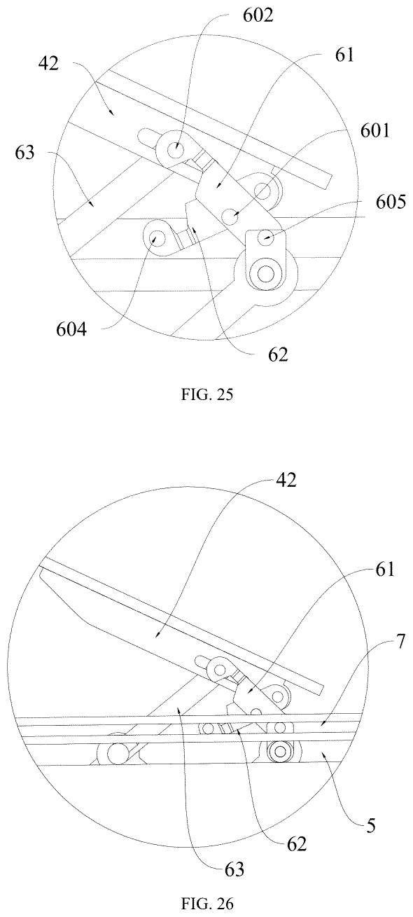

Specifically, the structure of the lifting and rotating bracket 6 remains unchanged, while the installation location and method are changed. As shown in FIGS. 25 and 26, the lifting and rotating bracket 6 includes a first connecting rod 61, a second connecting rod 62, and a drive connecting rod 63. The first connecting rod 61 and the second connecting rod 62 are hinged via a first pivot 601. The first pivot 601 is offset from the center point of the first connecting rod 61 and is located adjacent to the first end of the first connecting rod 61 (the end adjacent to the tailgate in FIG. 25). The first pivot 601 is offset from the center point of the second connecting rod 62 and is located adjacent to the first end of the second connecting rod 62 (the end adjacent to the tailgate in FIG. 25). The first end of the second connecting rod 62 is hinged to the second mounting arm 42. The first end of the drive connecting rod 63 is hinged to the second end of the first connecting rod 61 via a second pivot 602. The second pivot 602 is configured to be slidable relative to the second mounting arm 42, or the first end of the drive connecting rod 63 is directly hinged to the second mounting arm 42. The second end of the drive connecting rod 63 is slidably connected to the slideway 5 via a hinged third pivot 603. During the movement of the scissor mechanism, the second end of the drive connecting rod 63 can be driven to move along the slideway 5. In an embodiment, the second end of the drive connecting rod 63 is hinged to the upper end of the first support rod 2101 in the second intersecting rod assembly 212 via the hinged third pivot 603. During the movement of the scissor mechanism, the distance between the upper ends of the two support rods in the second intersecting rod assembly 212 changes, driving the second end of the drive connecting rod 63 to move along the slideway 5, thereby driving the second mounting arm 42 connected to the drive connecting rod 63 to rotate and lift or lower the second mounting arm 42, thereby preventing the cover plate 1 from interfering with the rear end and side walls of the truck bed during opening. As shown in FIG. 26, the mounting frame 20 is provided with a sliding slot 7, which is parallel to the slideway 5 and located above the slideway 5. The second end of the second connecting rod 62 is slidably connected to the sliding slot 7 via a hinged fourth pivot 604. The first end of the first connecting rod 61 is slidably connected to the sliding slot 7 via a hinged fifth pivot 605. The upper end of the first support rod 2102 of the second intersecting rod assembly 212 is connected to the first end of the first connecting rod 61 via a connector. During the movement of the scissor mechanism, the first support rod 2102 of the second intersecting rod assembly 212 drives the first end of the first connecting rod 61 to move synchronously on the sliding slot 7. The sliding slot 7 provides guidance and a limit for the sliding movement of the lifting and rotating bracket 6, enabling the lifting and rotating bracket 6 to move synchronously with the scissor mechanism while ensuring that the movement of the lifting and rotating bracket 6 and the scissor mechanism do not interfere with each other. The second end of the drive connecting rod 63 can be provided with a strip hole, and the third pivot 603 is sleeved in the strip hole to ensure that the tilt angle of the cover plate 1 is consistent after opening.

It should be noted that the terms “slideway” and “sliding slot” in the present disclosure are broadly defined, and encompass groove structures directly formed by machining as well as various linear guiding and limiting mechanisms constituted by additional guide rails, sliding rails, tracks, bushings, and sliding blocks/rollers. The specific shape, material, cross-section, arrangement, and connection manner thereof do not constitute limitations to the scope of protection of the present disclosure.

In an embodiment, the slideway 5 and the sliding slot 7 are provided at the mounting frame 20 and cooperate with the lifting and rotating bracket 6 and its associated connecting rods (for example, the first connecting rod 61, the second connecting rod 62, and the drive connecting rod 63) to provide linear guidance and stroke limitation during the entire unfolding and folding process of the scissor mechanism. The slideway 5 and the sliding slot 7 may be configured as longitudinally extending through-slots, such that relevant pivots or sliding blocks can slide therein along the length direction of the mounting frame 20. However, the slideway 5 and the sliding slot 7 are not limited to the form of through-slots. Any structure that can achieve equivalent guiding and limiting functions shall be regarded as an equivalent solution of the present disclosure.

In some embodiments, the slideway 5 and the sliding slot 7 may be directly machined on the mounting frame 20 to form recessed grooves, through-slots, stepped grooves, or composite cross-section grooves; alternatively, the guiding structure may be realized by additional components, such as fixing profile rails, T-slots, dovetail slots, C-shaped or U-shaped tracks, angle steel rails, embedded sliding rail components, extruded aluminum rails, or cold-bent steel rails onto the mounting frame 20, or integrating them with the mounting frame 20 by means of embedding, riveting, screwing, welding, or bonding. The cross-section of the rails may be rectangular, arc-shaped, trapezoidal, dovetail-shaped, T-shaped, or other suitable cross-sections; the guiding surface may be a bare metal surface, or it may be provided with a low-friction liner or a wear-resistant strip, such as PTFE, POM, nylon, composite wear-resistant layers, or replaceable wear-resistant inserts, so as to reduce wear and facilitate maintenance.

In some embodiments, the sliding cooperation members may adopt a sliding block-rail pair, a roller-track pair, a ball-circulation linear guide pair, or a sliding shoe-groove pair, and may also adopt the form of a sliding pin with a bushing sliding in the groove. The structure may be open, or may be configured as a closed or semi-closed cover structure to resist the intrusion of dust, rain, snow, and debris. Drain holes, flow channels, or sealing strips may be arranged at the bottom of the grooves or at low positions of the tracks. To improve the operating quality of the mechanism, preloading, clearance compensation, or lubrication devices may be provided in the guide pair, and grease cups, oil-containing bushings, or self-lubricating materials may be employed to reduce noise and friction. In addition, to enhance durability, replaceable wear-resistant liners may be provided on the guiding surfaces, and consumable parts may be designed as modular quick-replacement components.

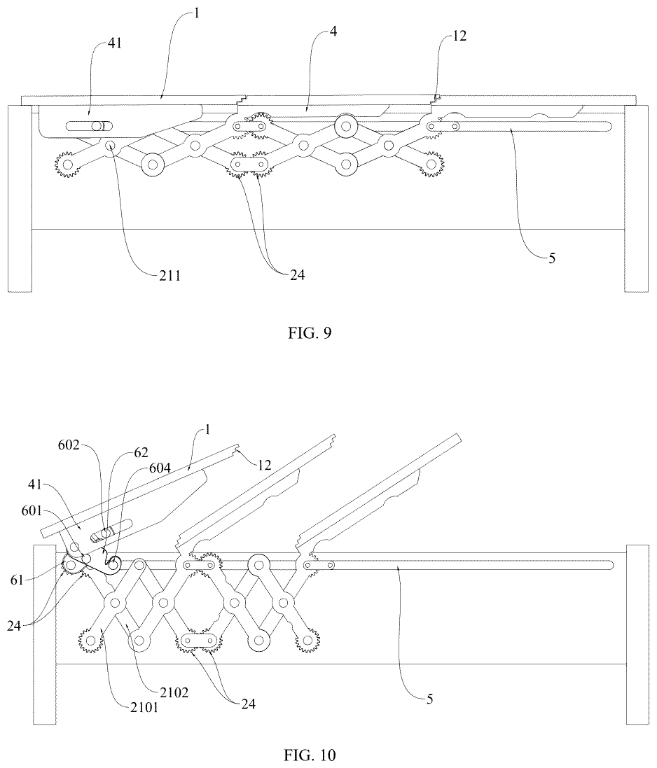

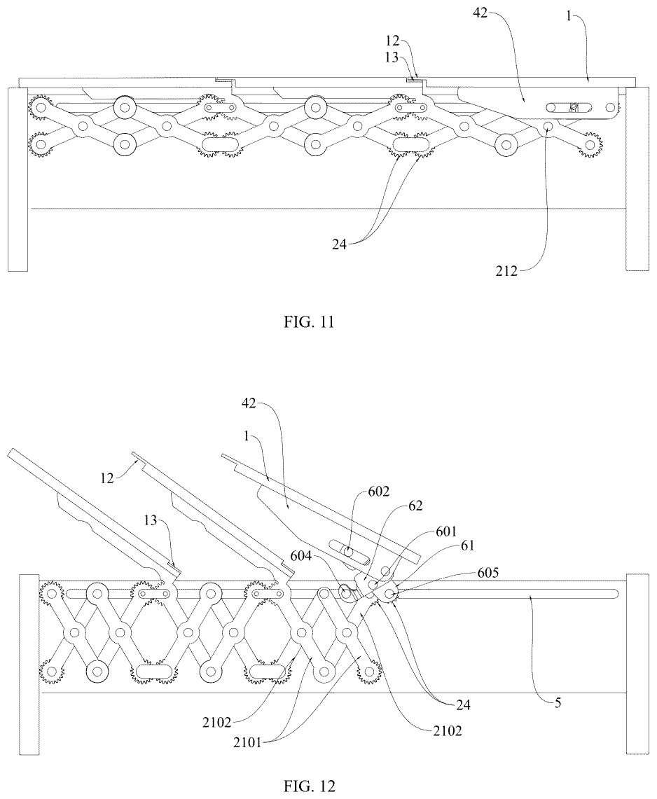

As shown in FIG. 9 and FIG. 10, the embodiment shows the case where the cover plate 1 is opened in a rearward tilting position, and the lifting and rotating bracket 6 is installed at the front of the truck bed adjacent to the cab 100. Similar to the previous embodiments, the scissor mechanism includes a plurality of intersecting rod assemblies 210 connected in sequence along the length of the truck bed, and each intersecting rod assembly 210 includes a pair of mutually hinged support rods. The difference between this embodiment and the above embodiments is that the ends of the two support rods of adjacent intersecting rod assemblies 210 are meshed by gears 24, and the rotating shafts or central axes of the two meshing gears 24 are connected together by a connecting member, which is slidably connected to the slideway 5, and the two maintain synchronous sliding. The form of the gear 24 includes an independent gear provided at the end of the support rod or a gear structure formed integrally at the end of the support rod.

The mounting frame 20 is provided with a slideway 5 arranged along the length of the truck bed, and the rotating shafts or central axes of the pair of gears 24 at the upper end are both configured to move along the slideway 5. Among the multiple intersecting rod assemblies 210, the intersecting rod assembly 210 located at the front end of the scissor mechanism adjacent to the cab 100 is defined as the first intersecting rod assembly 211. The upper end of the second support rod 2102 of the first intersecting rod assembly 211 is hinged to the mounting frame 20, and the hinge point is located at the end of the slideway 5 adjacent to the cab 100. The first intersecting rod assembly 211 is connected to the corresponding first mounting arm 41 among the multiple mounting arms 4 through the lifting and rotating bracket 6. When the scissor mechanism is folded, the pair of support rods of the first intersecting rod assembly 211 pivot relative to each other, where the second support rod 2102 of the first intersecting rod assembly 211 drives the lifting and rotating bracket 6 to drive the first mounting arm 41 to rotate and lift or lower the first mounting arm 41. Except for the first mounting arm 41, the other mounting arms 4 are connected to the first support rod 2101 of the corresponding intersecting rod assembly 210. The first mounting arm 41 rotates and rises under the action of the first intersecting rod assembly 211, passing over the front wall 32 of the truck bed, thereby preventing the cover plate 1 from interfering with the front wall 32 of the truck bed during rotation due to the cover plate 1 being larger than the truck bed after overlapping.

Specifically, between two adjacent fork rod assemblies, the upper end of the first support rod 2101 of one fork rod assembly is meshed with the upper end of the second support rod 2102 of the other fork rod assembly via a gear 24. The rotating shafts or central axes of the two gears 24 are slidably disposed on the slideway 5 and are connected with each other via a connector to maintain meshing, and the two maintain synchronous sliding. When the scissor mechanism is in the unfolded state, the distance from the connector to the cover plate 1 is greater than the distance from the connector to the top surface of the mounting frame 20 on both sides of the truck bed, thereby avoiding interference.

The lifting and rotating bracket 6 includes a first connecting rod 61 and a second connecting rod 62, and the first connecting rod 61 and the second connecting rod 62 are hinged via a first pivot 601. The first pivot 601 is offset from the center point of the first connecting rod 61 and is located adjacent to the first end of the first connecting rod 61. The first pivot 601 is also offset from the center point of the second connecting rod 62 and is located adjacent to the first end of the second connecting rod 62. The second end of the first connecting rod 61 is slidably connected to the first mounting arm 41 via a hinged second pivot 602, and the first end of the second connecting rod 62 is hinged to the first mounting arm 41. The first end of the first connecting rod 61 is hinged to the mounting frame 20, and the hinged position is located on the extension line of the slideway 5. The second end of the second connecting rod 62 is slidably connected to the slideway 5 via a hinged fourth pivot 604. The upper end of the second support rod 2102 of the first intersecting rod assembly 211 is hinged to the mounting frame 20 and meshes with the first end of the first connecting rod 61 via a gear 24. The gear 24 structure can be integrally processed with the support rod, or a separate gear 24 can be fixed to the end of the support rod. During the folding process of the scissor mechanism, the second support rod 2102 of the first intersecting rod assembly 211 rotates with the hinge shaft at the upper end as the rotation axis, and drives the first connecting rod 61 to rotate through the gear 24, thereby realizing the rotation and lifting movement of the first mounting arm 41, avoiding the protruding edge of the cover plate 1 from interfering with the front wall 32 of the truck bed when the cover plate 1 rotates.

As shown in FIG. 11 and FIG. 12, this embodiment is similar to the above embodiment in structure, except that in this embodiment the cover plate 1 is folded in a forward tilting posture, and the lifting and rotating bracket 6 is installed at the rear of the truck bed adjacent to the tailgate 101.

The scissor mechanism includes a plurality of intersecting rod assemblies 210 connected in sequence along the length of the truck bed. Each intersecting rod assembly 210 includes a pair of mutually hinged support rods. The ends of the two support rods of adjacent intersecting rod assemblies 210 are meshed by gears 24. The rotating shafts or central axes of the two meshing gears 24 are connected together by a connector, and the two maintain synchronous sliding. The form of the gear 24 includes an independent gear provided at the end of the support rod or a gear structure formed integrally at the end of the support rod. A slideway 5 arranged along the length of the truck bed is provided on the mounting frame 20. The rotating shafts or central axes of the pair of gears 24 at the upper end are both configured to move along the slideway 5. Among the plurality of intersecting rod assemblies 210, the intersecting rod assembly 210 located at the rear end of the scissor mechanism adjacent to the tailgate 101 positions the second intersecting rod assembly 212. The upper ends of the two support rods of the second intersecting rod assembly 212 are both slidably connected to the slideway 5 on the mounting frame 20. The second intersecting rod assembly 212 is connected to the corresponding second mounting arms 42 of the plurality of mounting arms 4 via the lifting and rotating bracket 6.

When the scissor mechanism is folded, the pair of support rods of the second intersecting rod assembly 212 pivot relative to each other. The second support rod 2102 of the second intersecting rod assembly 212 drives the lifting and rotating bracket 6 to rotate and lift or lower the second mounting arm 42. Simultaneously, the lifting and rotating bracket 6, driven by the second intersecting rod assembly 212, slides along the slideway 5 toward the front of the truck bed along with the second intersecting rod assembly 212. The mounting arms 4, except for the second mounting arm 42, are connected to the first support rod 2101 of the corresponding intersecting rod assembly 210. The second mounting arm 42 rotates and lifts under the action of the second intersecting rod assembly 212, preventing the cover plate 1 from interfering with the rear frame of the truck bed during rotation due to the cover plate 1 being larger than the truck bed after being overlapped.

Specifically, the structure of the lifting and rotating bracket 6 is the same as that of the above embodiment. The lifting and rotating bracket 6 includes a first connecting rod 61 and a second connecting rod 62. The first connecting rod 61 and the second connecting rod 62 are hinged via a first pivot 601. The first pivot 601 is offset from the center point of the first connecting rod 61 and adjacent to the first end of the first connecting rod 61. The first pivot 601 is offset from the center point of the second connecting rod 62 and adjacent to the first end of the second connecting rod 62. The second end of the first connecting rod 61 is slidably connected to the second mounting arm 42 via the hinged second pivot 602. The first end of the second connecting rod 62 is hinged to the second mounting arm 42. The second end of the second connecting rod 62 is slidably connected to the slideway 5 via the hinged fourth pivot 604, and the first end of the first connecting rod 61 is slidably connected to the slideway 5 via the hinged fifth pivot 605. The upper end of the second support rod 2102 of the second intersecting rod assembly 212 is slidably connected to the slideway 5 via the hinged pivot and is meshed with the first end of the first connecting rod 61 via the gear 24. The meshed ends are connected with each other via a connecting member and remain in meshed state. The two maintain synchronous sliding. During the rotation of the second support rod 2102 of the second intersecting rod assembly 212, the first connecting rod 61 is driven to rotate via the gear 24. At the same time, since the second support rod 2102 of the second intersecting rod assembly 212 itself moves along the slideway 5, the lifting and rotating bracket 6 slides synchronously with the second support rod 2102 of the second intersecting rod assembly 212.

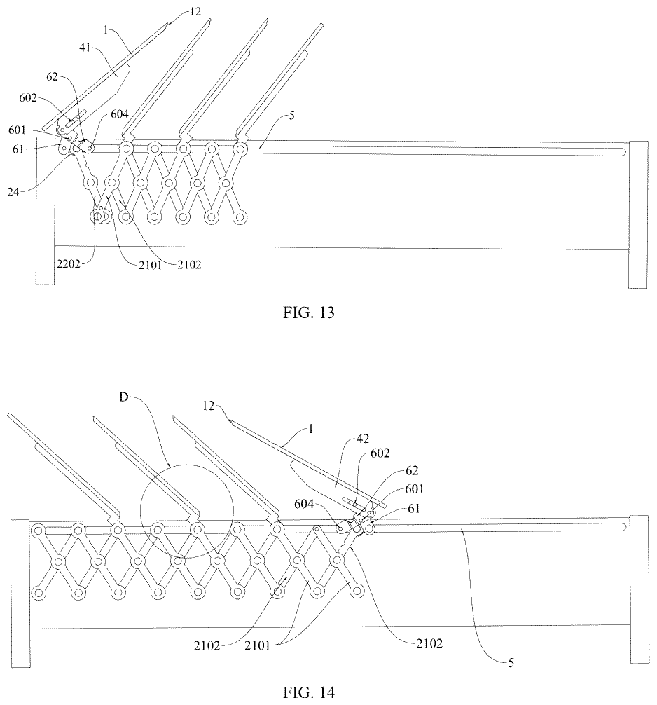

As shown in FIG. 13, this embodiment is a rearward-tilting structure of the cover plate 1, and the lifting and rotating bracket 6 is installed at the front of the truck bed adjacent to the cab 100. The scissor mechanism of this embodiment is the same as that of the above embodiment, and the connection between the scissor mechanism and the lifting and rotating bracket 6 is similar to that of the above embodiment, except that the first intersecting rod assembly 211 is simplified or replaced by a support rod 2202, and the lower end of the support rod 2202 is hinged to the lower end of the first support rod 2101 of the adjacent intersecting rod assembly 210, and the hinge point is located between the end and the center point of the rod body, thereby achieving the size adjustment of the cover plate 1 in the length direction of the truck bed. The upper end of the support rod 2202 is hinged to the mounting frame 20 and meshes with the first end of the first connecting rod 61 through the gear 24. The gear structure can be processed integrally with the support rod, or a separate gear 24 can be fixed to the end of the support rod. During the folding process of the scissor mechanism, the support rod 2202 rotates with the hinge shaft at the upper end as the rotation axis, and drives the first connecting rod 61 to rotate through the gear 24, thereby realizing the rotation and lifting movement of the first mounting arm 41.

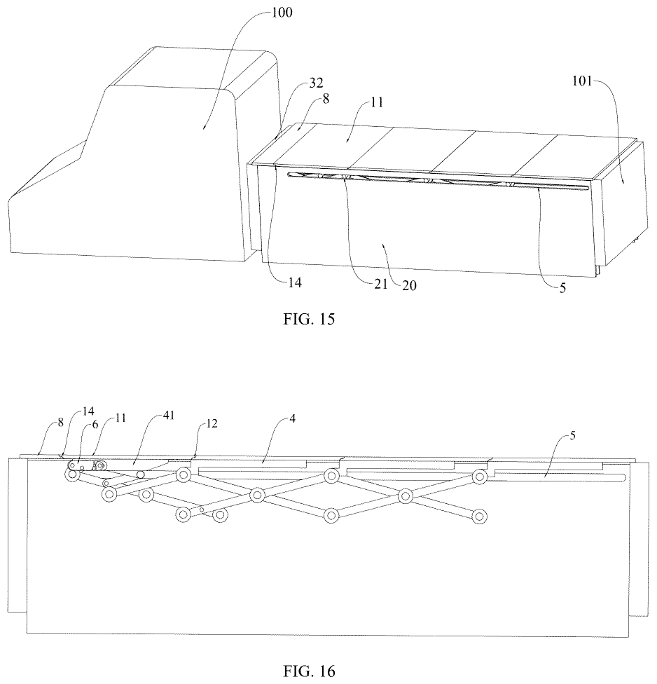

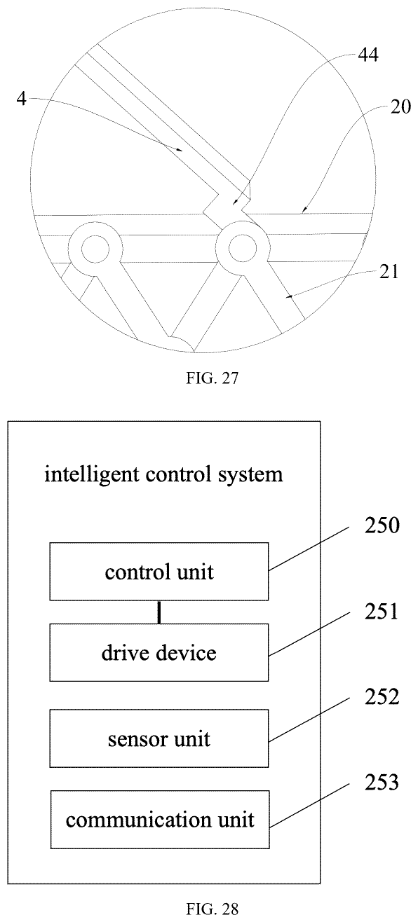

As shown in FIG. 14, the structure of the scissor mechanism is similar to that of the above embodiment. The lifting and rotating bracket 6 is mounted at the rear of the truck bed adjacent to the tailgate 101. The difference lies in the installation and driving method of the lifting and rotating bracket 6, which is the same as that of the above embodiment. As shown in FIG. 27, the ends of the mounting arms 4 other than the first mounting arm 41 connected to the corresponding support rods are provided with Z-shaped or similar connecting structure bent parts 44. This extends the distance between the mounting arms 4 and the upper ends of the support rods. When the scissor mechanism is in the unfolded state, the upper ends of the support rods are located outside the projection of the mounting arms 4 connected thereto on the plane of the truck bed top surface. This prevents the cover plate connected to the mounting arms 4 from interfering with the top surface of the truck bed or the mounting frame 20 during rotation.

As shown in FIG. 15 to FIG. 17, this embodiment shows the case where the cover plate 1 is opened in a rearward tilting posture, and the lifting and rotating bracket 6 is installed at the front of the truck bed adjacent to the cab 100. The intersecting rod assembly 210 includes two mutually hinged first support rods 2101 and second support rods 2102. Except for the first intersecting rod assembly 211, the hinge points of the two support rods of the other intersecting rod assemblies 210 are all located at the center of the rod body. The first intersecting rod assembly 211 adopts a deformable structure, where the first support rod 2101 of the first intersecting rod assembly 211 is connected to the first mounting arm 41, and the second support rod 2102 of the first intersecting rod assembly 211 is connected to the drive connecting rod 63 via the linkage connecting rod 64. The upper end of the second support rod 2102 of the first intersecting rod assembly 211 is hinged to the mounting frame 20, and the hinge point is located on the extension line of the slideway 5. The hinge point of the first support rod 2101 and the second support rod 2102 is offset from the center point of the second support rod 2102 and adjacent to the upper end of the second support rod 2102. When the first intersecting rod assembly 211 is hinged to the adjacent intersecting rod assembly 210, the intersection of the second support rod 2102 and the first support rod 2101 deviates from the lower end of the bar body, and the hinge point is located between the center and the lower end of the bar body.

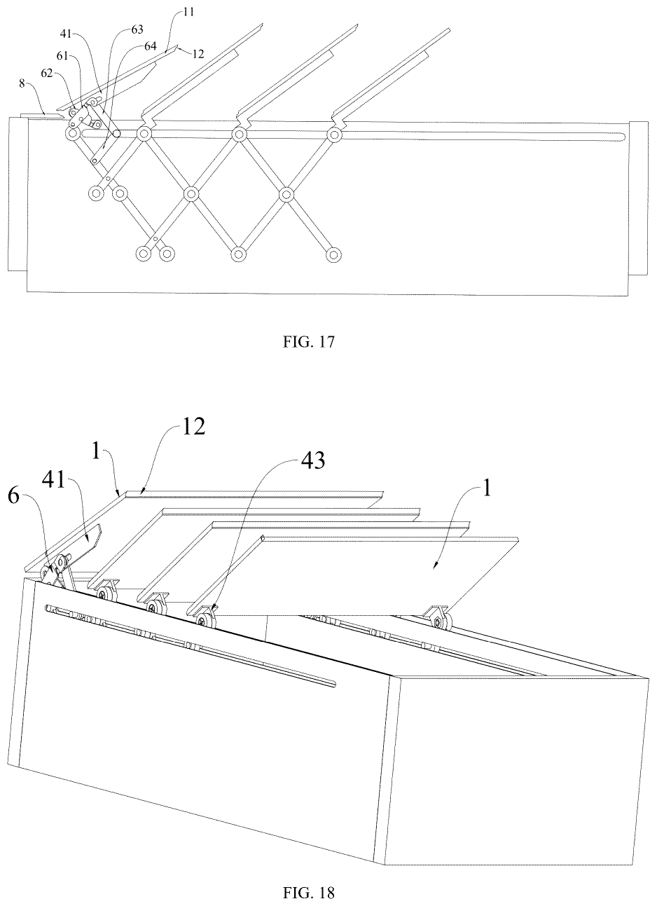

As shown in FIG. 16 and FIG. 17, this embodiment includes a waterproof plate 8 on the front wall 32 of the truck bed. The structure of the lifting and rotating bracket 6 is the same as that of the above embodiment, except that the second end of the drive connecting rod 63 is hinged to the upper end of the linkage connecting rod 64 via a hinge shaft, which is slidably disposed on the slideway 5, and the lower end of the linkage connecting rod 64 is hinged to the second support rod 2102 of the first intersecting rod assembly 211. During the movement of the scissor mechanism, the second support rod 2102 of the first intersecting rod assembly 211 rotates, driving the linkage connecting rod 64 to rotate, thereby driving the drive connecting rod 63 to rotate via the hinge shaft with the drive connecting rod 63. The drive connecting rod 63 then links with the first mounting arm 41 to achieve simultaneous lifting and rotation of the first mounting arm 41. When the scissor mechanism is unfolded, a second lapping part 14 is formed between the first cover plate 11 and the waterproof plate 8, located at the front end of the truck bed adjacent to the cab 100. Matching inclined surfaces, stepped surfaces, or curved surfaces are formed at the ends of the second lapping part 14. Sealing strips, such as those made of rubber or silicone, can be provided on these matching inclined surfaces, stepped surfaces, or curved surfaces to enhance the waterproof seal between the waterproof plate 8 and the cover plate. Furthermore, the waterproof plate 8 increases the distance between the first cover plate 11 and the front wall 32 of the truck bed, preventing interference between the first cover plate 11 and the front wall 32 of the truck bed during its lifting and rotation.

Compared to the above embodiment, the two support rods in the intersecting rod assembly 210 of the scissor mechanism are longer, so each intersecting rod assembly can be equipped with a corresponding mounting arm. Directly connecting the first intersecting rod assembly 211 to the upper hinge axis of the adjacent intersecting rod assembly would make the drive connecting rod 63 too long, affecting stability. Therefore, it is necessary to change the connection position of the lower end of the drive connecting rod 63, and thus add a linkage connecting rod 64 to achieve linkage between the second support rod 2102 of the first intersecting rod assembly 211 and the drive connecting rod 63. In this embodiment, the height of the mounting frame 20 is greater, which can increase the stability of its installation on the inner wall surface of the cab. It is understood that if the height of the side wall of the truck bed is smaller, the intersecting rod assembly composed of shorter support rods in the previous embodiment can be used. Therefore, by adjusting the quantity of fork rod assemblies in this embodiment, the size of the mounting frame 20 can be effectively changed. In addition, by adjusting the hinge point position of the intersecting rod assembly 210, the distance between the upper ends of the two support rods can be effectively changed. The cover plate 1 is connected to the first rod of each pair of intersecting rod assemblies 210 through a pair of mounting arms 4, thereby adjusting the size of the cover plate 1 in the length direction of the truck bed.

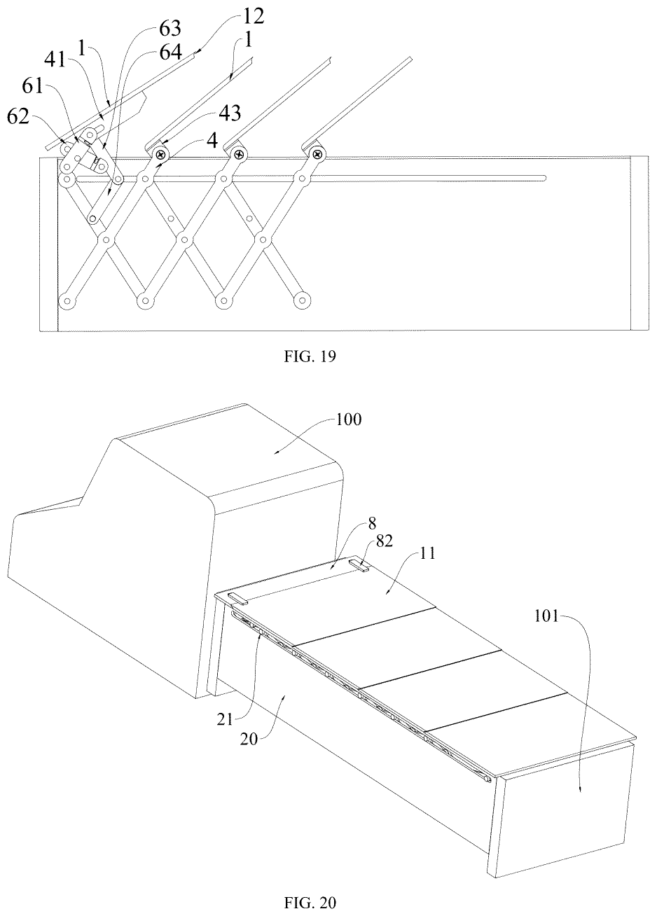

As shown in FIG. 18 and FIG. 19, this embodiment is a rearward-tilting structure of the cover plate 1, and the lifting and rotating bracket 6 is installed at the front of the truck bed adjacent to the cab 100. The structure of the scissor mechanism is similar to that of the above embodiment. The first support rod 2101 in the intersecting rod assembly 210 is connected to the mounting arm 4, which can also be an extension rod of the first support rod 2101. The cover plate 1 is provided with an ear plate 43, which is fixedly connected to the end of the mounting arm 4 and rotates with the mounting arm 4. Of the two hinge shafts of the adjacent intersecting rod assembly 210, the upper hinge shaft 22 is slidably connected to the slideway 5. The structure of the lifting and rotating bracket 6 is the same as that of the above embodiment, except that a linkage connecting rod 64 is added. The second end of the drive connecting rod 63 is hinged to the upper end of the linkage connecting rod 64 through a hinge shaft. The hinge shaft is slidably provided on the slideway 5, and the lower end of the linkage connecting rod 64 is hinged to the second support rod 2102 of the first intersecting rod assembly 211.

As shown in FIG. 20 to FIG. 23, the scissor mechanism of this embodiment is the same as that of the above embodiment, except that the lifting and rotating bracket 6 is eliminated. The difference is that a waterproof plate 8 is provided on the top surface of the front wall 32 of the truck bed to prevent interference between the mounting arm 4 and the front wall 32 of the truck bed. The first intersecting rod assembly 211 is connected to the corresponding first mounting arm 41 of the plurality of mounting arms 4 through the drive bracket 9. The first cover plate 11 connected to the first mounting arm 41 forms a second lapping part 14 with the waterproof plate 8, and the ends of the second lapping part 14 form matching inclined surfaces, stepped surfaces, or curved surfaces. The drive bracket 9 includes a first driving rod 91 and a second driving rod 92, which are hinged to each other via a sixth pivot 606, which is slidably disposed on the slideway 5. The second end of the first driving rod 91 is hinged to the first mounting arm 41, and the second end of the second driving rod 92 is hinged to the second support rod 2102 of the first intersecting rod assembly 211. The waterproof plate 8 defines an avoidance groove 81. When the scissor mechanism is folded, the first mounting arm 41 is positioned within the avoidance groove 81. A waterproof cover 82 is hinged to the waterproof plate 8. When the scissor mechanism is unfolded, the waterproof cover 82 covers the avoidance groove 81, preventing rainwater and dust from entering the truck bed through the avoidance groove 81. When the scissor mechanism begins to fold from the unfolded state, the waterproof cover 82 is opened by the force of the first cover plate 11 and rotates open with the first cover plate 11.

As shown in FIG. 1 to FIG. 23, a first lapping part 12 is formed between the cover plates 1 and the cover plates 1, and two adjacent cover plates 1 form mutually matching inclined surfaces, stepped surfaces or curved surface structures at the ends of the first lapping part 12. Moreover, the end structures of the first lapping part 12 between different cover plates 1 or the second lapping part 14 between the cover plate 1 and the waterproof plate 8 in the same embodiment can be different, which solves the problem that the cover plates 1 cannot be opened due to interference with each other due to being too tightly fitted. Furthermore, a seal 13 is provided at the lapping part to seal the gap between adjacent cover plates 1, prevent rainwater from seeping into the interior of the truck bed from the lapping part, and improve the waterproof effect.

As shown in FIG. 28, based on the above embodiments, the pickup truck tonneau cover of the present disclosure further includes an intelligent control system. The intelligent control system may include a control unit 250, a sensor unit 252 and a communication unit 253. The control unit 250 is electrically connected to the drive device 251, and is used to automatically control the folding or unfolding of the scissor mechanism according to the status signal collected by the sensor unit 252, thereby realizing the one-touch opening and closing, automatic reset or timed opening and closing functions of the cover plate. The sensor unit 252 may include a position sensor, a pressure sensor or an infrared detection device, which is used to detect the opening and closing position of the cover and its surrounding obstacles in real time. When an abnormal obstruction is detected, the control unit 250 immediately sends a stop or reverse drive signal to control the drive device 251 to prevent the user from being pinched. The communication unit 253 can be connected to the user terminal or the vehicle-mounted system through wireless communication. When it is detected that the tonneau cover is abnormally opened or pried, it can send an anti-theft warning signal to the user, and can record the number of opening and closing times and the operating status, thereby improving the safety and intelligent experience of use.

In another aspect of the present disclosure, a clamping device is provided. More specifically, a clamping device for installing a mounting frame of a pickup truck tonneau cover to a side wall of a pickup truck is provided.

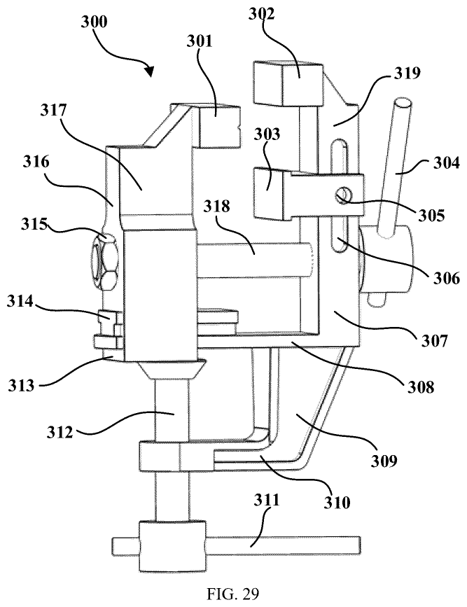

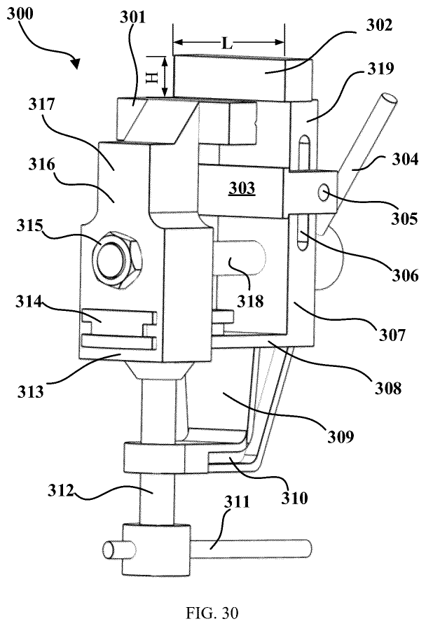

FIGS. 29 and 30 are schematic structural diagrams of a clamping device 300 according to an exemplary embodiment of the present disclosure from different angles. As shown, in this embodiment, the clamping device 300 includes a base body 307 and a movable body 316 that is movable relative to the base body 307. The base body 307 is provided with two first jaws 302 and 303, and the movable body 316 is provided with a second jaw 301. The movable body 316 is configured to move relative to the base body 307 to change a distance between the first jaws 302 and 303 and the second jaw 301 in a clamping direction (or a first direction).

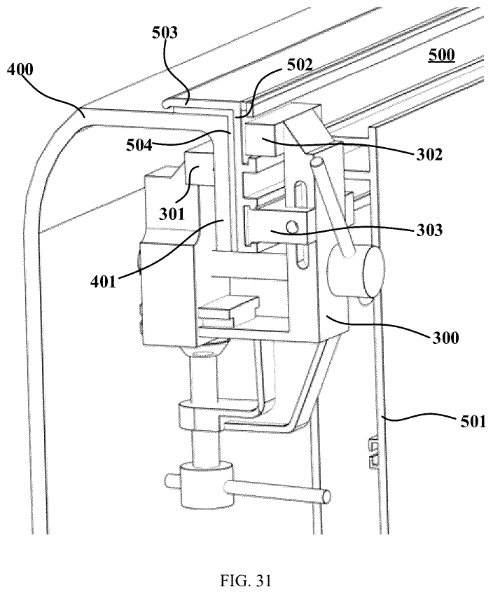

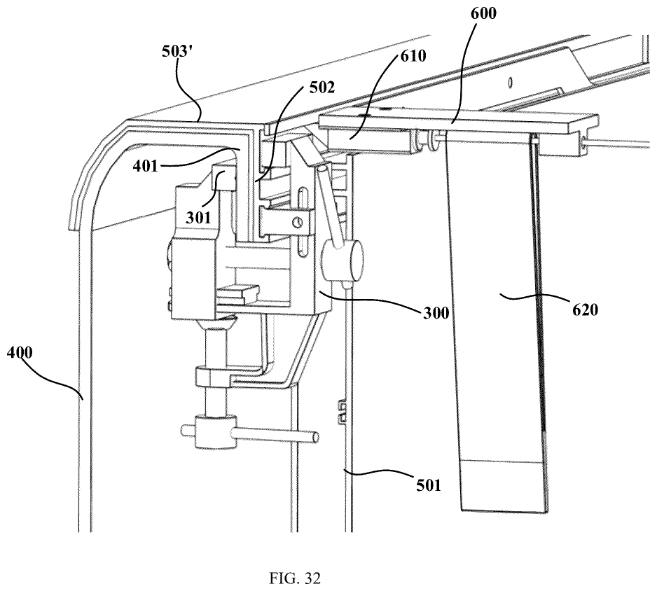

According to an exemplary embodiment, as shown in FIGS. 31 and 32, the clamping direction of the clamping device 300 is a substantially horizontal direction, an extending direction of the base body 307 is a substantially vertical direction (or a second direction), and the movable body 316 is configured to move relative to the base body 307 in the clamping direction, thereby changing a horizontal distance between the first jaws 302 and 303 and the second jaw 301. When the first jaws 302 and 303 and the second jaw 301 move toward each other, a side frame side wall 401 and a mounting frame side wall 502 are clamped between the first jaws 302 and 303 and the second jaw 301, thereby fixing the tonneau cover 500 to the side frame 400 of the truck bed of the pickup truck.

It should be noted that the clamping device 300 is not limited to being used vertically as shown in FIGS. 29 and 30. In some situations (not shown), the side frame side wall 401 may also include a horizontally arranged plate-like member, and the mounting frame 501 of the tonneau cover 500 may also include a horizontally arranged plate-like member and abut against the plate-like member of the side wall of the truck bed, such that the clamping device can be arranged horizontally. That is, an extending direction of the base body 307 is set to be a horizontal direction, such that the first jaws 302 and 303 and the second jaw 301 can clamp and fix the horizontally arranged plate-like member of the side wall of the truck bed and the horizontally arranged plate-like member of the mounting frame of the tonneau cover together from two sides along a substantially vertical direction.

In addition, the side frame side wall 401 may be originally provided on the side frame 400 of the truck bed, or may be obtained through appropriate modification or processing. For example, in the exemplary embodiments shown in FIGS. 31 and 32, an upper end of the side frame 400 of the truck bed is rolled inward to form the side frame side wall 401, and an inner side (a lower surface) of the upper end of the side frame 400 is open. In this case, the movable body 316 of the clamping device 300 can directly extend into an inner space of the side frame side wall 401. However, when the upper end of the side frame 400 of the truck bed is a substantially rectangular frame and a lower surface thereof is closed (not shown), a hole of an appropriate size may be processed (e.g., drilled) on the lower surface of the rectangular frame, such that the movable body 316 of the clamping device 300 can extend into an inner space of the rectangular frame through the hole, thereby achieving clamping and fixation between the side frame side wall 401 of the truck bed and the mounting frame side wall 502 of the tonneau cover 500.

In some solutions, a clamping device may have one first jaw and one second jaw, and the first jaw and the second jaw clamp a side wall of the truck bed and a mounting frame side wall of the tonneau cover in corresponding positions. However, in some use situations, for example, when a flexible spacer is provided between the side frame side wall of the truck bed and the mounting frame side wall of the tonneau cover, such clamping may cause the mounting frame to wobble or tilt relative to the side frame of the truck bed, thereby possibly affecting structural stability, or reducing smoothness of opening and closing of a folding mechanism.

In some embodiments of the present disclosure, the base body 307 of the clamping device 300 is provided with two first jaws 302 and 303. The two first jaws 302 and 303 are spaced apart from each other in a vertical direction as shown in FIGS. 29 and 30, and the second jaw 301 is arranged, in the vertical direction, between the two first jaws 302 and 303. Such a structure can stably clamp the side wall of the truck bed and the mounting frame side wall of the tonneau cover between the first jaws and the second jaw in a horizontal direction, thereby avoiding wobbling or tilting of the mounting frame relative to the side frame of the truck bed. In addition, in general, the second jaw 301 on the movable body is generally positioned on an inner side of the side frame side wall 401 as shown in FIGS. 31 and 32, and its space and size are generally limited, while an outer side of the side frame side wall 401 (a side facing an inner space of the truck bed) generally has sufficient space. Therefore, a single second jaw 301 is more suitable for the side frame side wall 401 with limited inner space of the side frame 400 of the truck bed.

A contact surface between the second jaw 301 and the side frame side wall 401 and contact surfaces between the first jaws 302 and 303 and the mounting frame side wall 502 are preferably square or rectangular, and more preferably, these contact surfaces are rectangular with a width greater than a height. As shown in FIG. 30, a contact surface between the first jaw 302 and the mounting frame side wall 502 is rectangular, with a width of L and a height of H, and the width L may be set to be 2 to 4 times the height H. For example, according to specific sizes of the truck bed and the mounting frame, the height H may be 1 to 2 cm, and the width L may be 2 to 8 cm. On one hand, a smaller height H can accommodate the limited inner space of 401, and on the other hand, a larger length L can provide a more stable clamping and fixing effect.

According to a more preferred embodiment, the two first jaws may include a first fixed jaw 302 and a first adjustable jaw 303, such that a distance between the first fixed jaw 302 and the first adjustable jaw 303 is adjustable as needed. Specifically, as shown in FIGS. 29 and 30, the base body 307 may be provided with a sliding slot 306 extending along a vertical direction, and the first adjustable jaw 303 may be movably mounted in the sliding slot 306 via a bolt (not shown) that passes through the hole 305 in the first adjustable jaw 303 and the sliding slot 306 and is fastenable or loosenable, such that a position of the first adjustable jaw 303 in the vertical direction relative to the first fixed jaw 302 is changeable. With such a structure, a distance between the two first jaws 302 and 303 is adjustable according to a size of the side frame side wall 401 and a size of the mounting frame side wall 502, which is conducive to more stably clamping and fixing the side frame side wall 401 and the mounting frame side wall 502 together.

Although in the embodiment shown in FIGS. 29 and 30, the upper first jaw 302 is a fixed jaw and the lower first jaw 303 is an adjustable jaw, setting the upper first jaw 302 as an adjustable jaw and setting the lower first jaw 303 as a fixed jaw can also achieve the purpose of the present disclosure.

In addition, although in the illustrated embodiment, during use of the clamping device, the movable body is disposed in the side frame of the truck bed, if an inner space of the side frame of the truck bed is sufficient, the base body may be disposed in the side frame of the truck bed and the movable body may be disposed outside the side frame of the truck bed (i.e., in an inner space of the truck bed). Further, in an equivalent embodiment not shown, two jaws (a fixed jaw or an adjustable jaw) may be provided on the movable body, and only one jaw may be provided on the base body. In addition, the two jaws may both be fixed jaws, or may both be adjustable jaws. Further, the second jaw 301 may also have two or more jaws, but these second jaws are arranged horizontally rather than vertically, such that the plurality of second jaws are positioned, in the vertical direction, between the two first jaws 302 and 303. Various equivalent changes may be made to the number, arrangement, adjustability, and the like of the jaws without departing from the basic principles of the present disclosure.

In the exemplary embodiment shown in FIGS. 29 and 30, the base body 307 may have a base portion 308 extending along a horizontal direction and a first extension portion 319 extending in a vertical direction. The two first jaws 302 and 303 are arranged on the first extension portion 319, and the base portion 308 is provided with a slide rail 314 extending along the horizontal direction. The movable body 316 is configured to move along the slide rail 314, thereby changing a horizontal distance between the first jaws 302 and 303 and the second jaw 301 to achieve clamping of the side frame side wall 401 and the mounting frame side wall 502.

In addition, the clamping device 300 further includes a first fastening bolt 318. The first fastening bolt 318 is arranged in a horizontal direction, and has a first part (a right part in FIG. 29) passing through the first extension portion 319 of the base body 307 and a second part (a left part in FIG. 29) passing through the movable body 316, and the second part is in threaded engagement with the movable body 316. By providing a first operating portion 304 in a form of a handle, a knob, an operating rod, or the like on the first part of the first fastening bolt 318, the first fastening bolt 318 can be rotated, thereby driving the movable body 316 to move along the slide rail 314. In addition, a fastening nut 315 may be provided at an end of the second part of the first fastening bolt 318, such that in a case where the clamping device 300 is clamped via the first fastening bolt 318, loosening of the first fastening bolt 318 is prevented.

To provide a more stable clamping state, according to a preferred embodiment, as shown in FIGS. 29 and 30, the movable body 316 has an upper part 317 located above the slide rail 314 in a vertical direction and a lower part 313 located below the slide rail 314 in the vertical direction, and the second jaw 301 is arranged on the upper part 317. The lower part 313 includes a portion extending below the base portion 308 of the base body and abutting against a lower surface of the base portion 308, such that the movable body surrounds an outer periphery of the slide rail 314, thereby improving stability of movement of the movable body 316 along the slide rail 314.

In addition, in a further exemplary embodiment, as shown in FIGS. 29 and 30, the base body 307 further includes a second extension portion 309 extending from the base portion 308 toward a direction opposite to an extending direction of the first extension portion 319, and an end of the second extension portion 309 has a bent portion 310; the clamping device 300 further includes a second fastening bolt 312 in threaded engagement with the bent portion 310, and an upper end of the second fastening bolt 312 is configured to abut against a lower surface of the second part of the movable body 316. In this way, when the movable body and the base body clamp the side wall of the truck bed and the mounting frame side wall, the second fastening bolt 312 can firmly abut the movable body 316 against the lower surface of the base portion 308, thereby further avoiding loosening and wobbling therebetween.

Similarly, a second operating portion 311 in a form of a handle, a knob, an operating rod, or the like may be provided at a lower end of the second fastening bolt 312, such that the second fastening bolt 312 can be rotated to drive the second fastening bolt 312 to move upward relative to the bent portion 310 to abut against the lower surface of the second part of the movable body 316.

To firmly fix the mounting frame 501 of the tonneau cover 500 to the side frame of the truck bed, at least two clamping devices 300 may be provided on each side of the truck bed. For example, one of the clamping devices 300 is used to clamp and fix the side frame side wall 401 and the mounting frame side wall 502 together at a position of the truck bed close to the cab, and another clamping device 300 is used to clamp and fix the side frame side wall 401 and the mounting frame side wall 502 together at a position of the truck bed close to a tail end. In addition, according to a size of the truck bed and a weight of the tonneau cover (especially the mounting frame), one or more additional clamping devices may be additionally provided at an appropriate position between the above two clamping devices for clamping and fixing the side frame side wall 401 and the mounting frame side wall 502. In addition, although the specification of the present disclosure only describes in detail fixation between the side frame on one side of the truck bed and a corresponding mounting frame of the tonneau cover, a side frame on the other side of the truck bed and another mounting frame of the tonneau cover may use the same clamping device 300 and be installed and fixed in the same or a similar manner.

In yet another aspect of the present disclosure, a pickup truck tonneau cover assembly is provided. The pickup truck tonneau cover assembly includes the pickup truck tonneau cover 500 according to any one of the foregoing exemplary embodiments and the clamping device 300 according to any one of the foregoing exemplary embodiments for fixing the pickup truck tonneau cover to a truck bed of a pickup truck.

Specifically, the truck bed includes two side frames 400 respectively located on two sides of the truck bed, and the pickup truck tonneau cover 500 includes two mounting frames 501 respectively mounted on the two side frames of the truck bed of the pickup truck. Each side frame 400 has a side frame side wall 401 abutting against a corresponding mounting frame side wall 502. The clamping device 300 includes: a base body 307 provided with two first jaws 302 and 303; and a movable body 316 provided with a second jaw, the movable body being configured to move relative to the base body 307 to change a distance between the first jaws 302 and 303 and the second jaw 301 in a horizontal direction (i.e., a clamping direction) shown in the drawings. The two first jaws 302 and 303 are spaced apart from each other in a vertical direction shown in the drawings, and the second jaw 301 is arranged, in the vertical direction, between the two first jaws 302 and 303. The side frame side wall 401 and the mounting frame side wall 502 are clamped and fixed between the two first jaws 302 and 303 and the second jaw 301 of the clamping device 300.

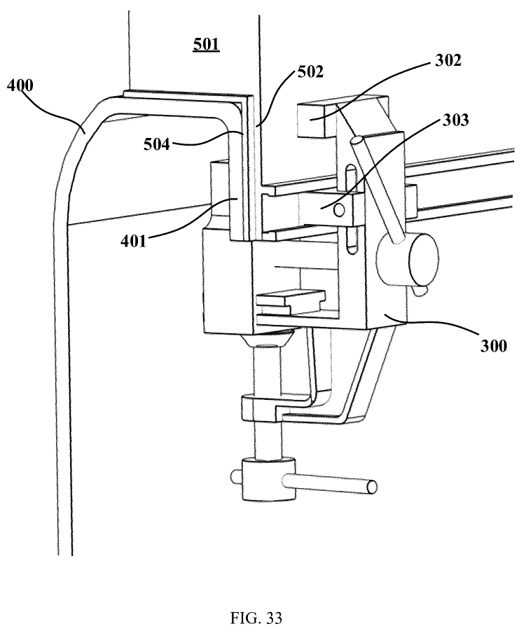

FIGS. 31 and 33 show two installation modes of the tonneau cover on the truck bed.

In the exemplary embodiment shown in FIG. 31, the mounting frame 501 of the tonneau cover 500 is mounted and fixed on an inner side of the side frame side wall 401 of the side frame 400 of the truck bed. The mounting frame 501 further includes a horizontal plate-like member 503 located at an upper end thereof, and the horizontal plate-like member 503 can press on an upper end surface of the side frame 400 of the truck bed. According to an exemplary alternative embodiment, as shown in FIG. 32, the difference from the embodiment of FIG. 31 lies in that an upper end of the mounting frame 501 is provided with an inverted U-shaped plate-like member 503′ sleeved on an upper end of the side frame 400 of the truck bed. That is, the inverted U-shaped plate-like member replaces the horizontal plate-like member 503 in the embodiment of FIG. 31. A specific cross-sectional shape of the inverted U-shaped plate-like member 503′ may be set to be consistent with a shape of the upper end of the side frame of the truck bed, thereby helping to more stably fix the mounting frame to the side frame of the truck bed.

According to the embodiments of the tonneau cover described above, in this embodiment, cover plates of the tonneau cover in a closed state can overlap an upper surface of the plate-like member 503. In this case, the tonneau cover in the closed state is substantially flush with the side frame 400 of the truck bed in height, which is also one of conventional arrangement modes of the tonneau cover.

In the embodiment shown in FIG. 31, a flexible material layer 504 may be arranged at any one of a position between the mounting frame side wall 502 and the side frame side wall 401 and a position between the plate-like member 503 and an upper surface of the side frame 400 of the truck bed, or at both positions. The flexible material layer 504 can protect the side frame of the truck bed, thereby avoiding damage to a paint layer on a surface of the side frame of the truck bed during installation of the tonneau cover. In addition, an appropriate material may be selected such that the flexible material layer 504 can further provide a waterproof sealing effect between the side frame 400 and the mounting frame 501.

In the exemplary embodiment shown in FIG. 33, the mounting frame 501 of the tonneau cover 500 is mounted and fixed on an upper side of the side frame 400 of the truck bed. In this embodiment, the mounting frame side wall 502 may be formed by an inner wall of the mounting frame 501 (i.e., a wall facing an inner side of the truck bed) extending downward, and a lower surface of the mounting frame 501 abuts against an upper surface of the side frame 400. According to this embodiment, an overall height of the tonneau cover is above the side frame 400 of the truck bed, thereby forming a larger enclosed space between the tonneau cover and the truck bed, so as to accommodate more cargo or items.

Similarly, a flexible material layer 504 may be arranged at any one of a position between the mounting frame side wall 502 and the side frame side wall 401 and a position between a lower surface of the mounting frame 501 and an upper surface of the side frame 400, or at both positions. The flexible material layer 504 is used to protect a paint layer of the side frame of the truck bed. In addition, an appropriate material may be selected such that the flexible material layer 504 can further provide a waterproof sealing effect between the side frame 400 and the mounting frame 501.

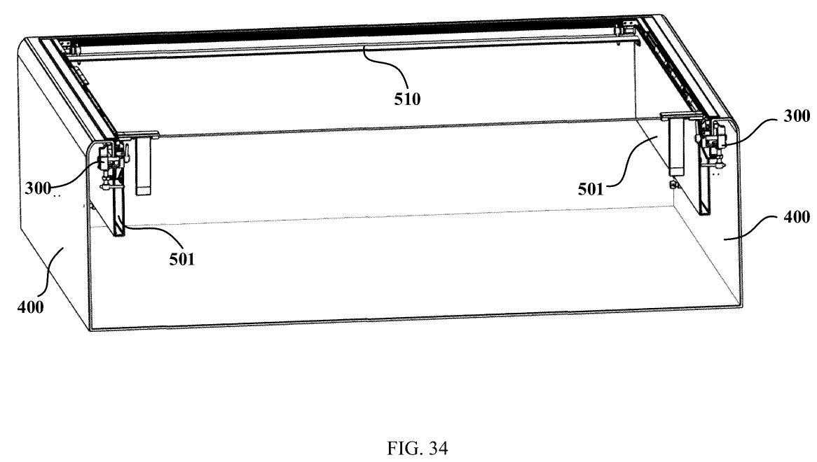

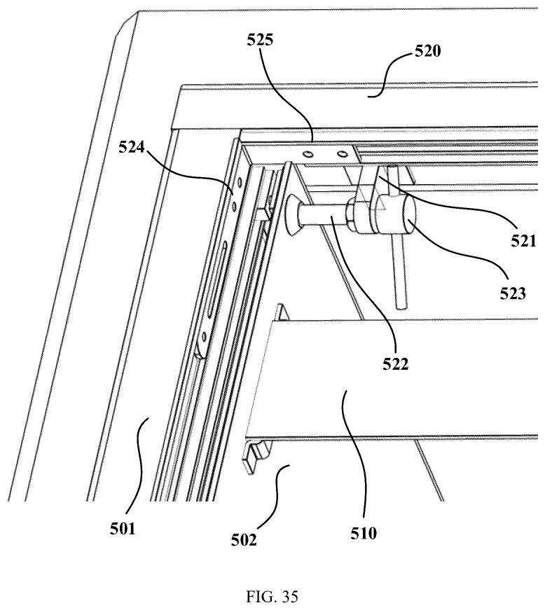

FIG. 34 is a schematic diagram of an installation of a tonneau cover assembly according to another exemplary embodiment of the present disclosure. In some situations, for example, when the side frame side wall of the truck bed is a complete plane from top to bottom, the clamping device of the present disclosure cannot be used. In this case, according to an exemplary embodiment of the present disclosure, in addition to the mounting frames 501 mounted to the side frames 400 of the truck bed and the clamping devices 300 described above, the tonneau cover assembly further includes a tightening apparatus. The tightening apparatus is generally arranged adjacent to the cab of the pickup truck. The tightening apparatus is used to press against the mounting frames 501, such that the mounting frame side walls 502 tightly abut against the side frame side walls 401.

In the illustrated exemplary embodiment, the tightening apparatus 510 is made of a rigid material, and two ends of the tightening apparatus 510 respectively press against appropriate positions of the two mounting frames 501 located on two sides of the truck bed, for example, walls of the mounting frames 501 facing an inner space of the truck bed. In the exemplary embodiment shown in FIG. 34, the tightening apparatus 510 is a plate-like member, and two ends of the plate-like member are respectively provided with bent plates having an area for abutting against side walls of the mounting frames 501, and a bent portion is provided with a threaded hole, so as to be further fastened to the mounting frames 501 via screws or bolts (not shown). In other possible but not shown embodiments, the tightening apparatus 510 may also be a tubular member, a rod member, a channel steel member, or the like with flanges at two ends. In addition, the tightening apparatus may also have an adjustable-length structure to adapt to different sizes of pickup truck beds. For example, an adjustable-length tubular member or rod member may be used.

FIG. 35 is a schematic diagram of an installation of a tonneau cover assembly according to yet another exemplary embodiment of the present disclosure. FIG. 35 shows another tightening structure acting on the mounting frames 501. In this embodiment, the tonneau cover assembly further includes a mounting plate 520 mounted to a front wall of the truck bed or a rear wall of a cab. The mounting plate 520 is provided with a protruding plate-like structure or lug 521. The plate-like structure or lug 521 is in threaded engagement with a tightening bolt 522 similar to the second fastening bolt 312. One end of the tightening bolt 522 is provided with a third operating portion 523, and the other end of the tightening bolt 522 abuts against a wall of the mounting frame 501. When the operating portion 523 is rotated, the tightening bolt 522 can move toward the mounting frame 501 relative to the plate-like structure 521, thereby tightening the mounting frame 501 such that the mounting frame 501 firmly abuts against the side frames 400 of the truck bed.

In addition, the mounting plate 520 is not only used to mount the tightening bolts 522, and the mounting plate 520 may also have, at two ends thereof, positioning structures matching shapes of end portions of the mounting frames 501 on two sides. In the embodiment shown in FIG. 35, a bent plate 524 is fixedly arranged at an end portion of the mounting frame, and a bent portion at an end of the bent plate 524 is positioned in a corresponding groove 525 at an end of the mounting plate 520, so as to position the mounting frame 501 during installation of the tonneau cover assembly, and to fix the end portion of the mounting frame 501 after installation. In other embodiments not shown, a protruding rod member may also be provided at an end portion of the mounting frame 501, and a corresponding hole may be provided at an end of the mounting plate 520. It is only required that matching positioning devices are provided at end portions of the two.

In another aspect of the present disclosure, a locking structure of the tonneau cover assembly is further provided. As described above, the tonneau cover according to the present disclosure can be opened and closed by switching the folding mechanism 21 of the folding apparatus 2 between a folded state and an unfolded state. According to one embodiment, the folding mechanism 21 of the present disclosure includes a scissor mechanism formed by sequentially connecting a plurality of connecting rods. Therefore, a linkage relationship is formed among the connecting rods, and only one connecting rod needs to be locked, and the other connecting rods are all locked and cannot move, such that the entire folding mechanism 21 is locked. In addition, the cover plate 1 is connected to the folding mechanism 21 via the mounting arms 4 and is linked with the folding mechanism 21. Therefore, locking the cover plate 1, the mounting arms 4, the connecting rods, or a pivot of a connecting rod sliding in the slideway 5 can also achieve a locking effect on the folding mechanism 21.

In a closed state of the tonneau cover, to prevent theft or accidental opening, it is beneficial to lock the tonneau cover in the closed state. Similarly, in an open state of the tonneau cover, to prevent accidental closing, it is beneficial to lock the tonneau cover in the open state. To this end, according to an exemplary embodiment, the tonneau cover assembly of the present disclosure further includes a locking mechanism for locking the folding mechanism 21, the mounting arms 4, or the cover plates 1. The locking mechanism may be a spring lock commonly used. When connecting rods of the folding mechanism 21, the mounting arms 4, or the cover plates 1 move to a predetermined position or angle, the spring lock can automatically lock. The spring lock can be unlocked by a manual unlocking mechanism such as a pull rope or a pull rod, or can be unlocked by a remotely controlled or electrically controlled unlocking mechanism. In some embodiments, the spring lock may be implemented by a locking structure commonly used in the art. For ease of description, all possible specific structures and operation modes thereof are not described one by one herein, but the scope of protection of the present disclosure is not limited thereto.

In the embodiment shown in FIG. 32, the tonneau cover assembly further includes a locking device, for example, a spring lock 610. The spring lock can be fixed to a cover plate of the tonneau cover 500 (not shown) via a lock fixing member (for example, a fixing plate 600). A bolt of the spring lock can cooperate with a bolt hole (not shown) provided on the mounting frame 501 to lock the cover plate in a horizontal state (a closed state). In addition, an unlocking device may also be provided at a rear end of the bolt. For example, a handle 620 exemplarily shown in FIG. 32 may be pulled rightward manually to pull the bolt of the spring lock 610 out of the bolt hole, thereby unlocking the cover plate. The bolt hole may be a bolt hole processed on the mounting frame 501, or a separate component having the bolt hole may be fixed to the mounting frame.

In other embodiments not shown, the locking device (e.g., a spring lock) may also be arranged on a mounting arm of a cover plate or a connecting rod of a folding mechanism, and be configured such that when the mounting arm rotates to a predetermined angle or when a connecting rod of the folding mechanism moves to a predetermined position, a bolt of the spring lock cooperates with a bolt hole at a specific position on the mounting frame, thereby achieving locking.

In the description of the present disclosure, it should be understood that the terms “first” and “second” are used for descriptive purposes only and should not be understood to indicate or imply relative importance or implicitly specify the number of the technical features indicated. Therefore, a feature defined as “first” or “second” may explicitly or implicitly include one or more of the features. In the description of the present disclosure, “plurality” means two or more, unless otherwise specifically defined.

In the present disclosure, unless otherwise specified or limited, the terms “mounted”, “connected”, “connect”, “fixed”, etc. should be understood broadly. For example, they can refer to fixed connection, detachable connection, or integral formation; mechanical connection or electrical connection; direct connection or indirect connection through an intermediate medium; internal communication between two components or interaction between two components. Those skilled in the art will understand the specific meanings of the above terms in the present disclosure based on the specific circumstances.

In the present disclosure, unless otherwise expressly specified and defined, when a first feature is “on” or “under” a second feature, the first and second features may be in direct contact, or may be in indirect contact through an intermediate medium. Furthermore, when the first feature is “above,” “over,” or “on top of” the second feature, the first feature may be directly above or obliquely above the second feature, or may merely indicate that the first feature is at a height higher than that of the second feature. When the first feature is “below,” “under,” or “beneath” the second feature, the first feature may be directly below or obliquely below the second feature, or may merely indicate that the first feature is at a height lower than that of the second feature.

In the description of the present specification, the expressions “one embodiment,” “some embodiments,” “an embodiment,” “example,” “specific example,” or “some examples” mean that the specific features, structures, materials, or characteristics described in connection with the embodiment or example are included in at least one embodiment or example of the present disclosure. In the present specification, the schematic representations of the above terms do not necessarily refer to the same embodiment or example. Furthermore, the specific features, structures, materials, or characteristics described may be combined in any suitable manner in one or more embodiments or examples. In addition, without conflict, those skilled in the art can combine and integrate different embodiments or examples described in the present specification and the features of different embodiments or examples.

Although the embodiments of the present disclosure have been illustrated and described above, it should be understood that the above embodiments are exemplary and should not be construed as limiting the present disclosure. Those of ordinary skill in the art can make changes, modifications, substitutions, and variations to the above embodiments within the scope of the present disclosure.

1. A clamping device, comprising: a first component provided with a first jaw; and a second component provided with a second jaw,
wherein the first component and the second component are configured to move toward or away from each other in a first direction to change a distance between the first jaw and the second jaw to achieve clamping; and
wherein one of the first jaw and the second jaw comprises two jaws spaced apart from each other in a second direction perpendicular to the first direction, and the other of the first jaw and the second jaw is arranged, in the second direction, between the two jaws.

2. The clamping device of claim 1, wherein one of the two jaws is a fixed jaw and the other of the two jaws is an adjustable jaw, and the adjustable jaw is arranged in a sliding slot extending along the second direction, such that a position of the adjustable jaw in the second direction relative to the fixed jaw is changeable.

3. The clamping device of claim 1, wherein the first component has a base portion extending along the first direction and a first extension portion extending in the second direction, and the base portion is provided with a slide rail extending along the first direction, and the second component is configured to move along the slide rail.

4. The clamping device of claim 3, further comprising a first fastening bolt extending along the first direction and having a first part passing through the first extension portion of the first component and a second part passing through the second component, wherein the second part of the first fastening bolt is in threaded engagement with the second component.

5. The clamping device of claim 3, wherein the second component has, in the second direction, an upper part located above the slide rail and a lower part located below the slide rail, and the lower part extends below the base portion and abuts against a lower surface of the base portion.

6. The clamping device of claim 5, wherein the first component further comprises a second extension portion extending from the base portion toward a direction opposite to an extending direction of the first extension portion, and an end of the second extension portion has a bent portion; and
the clamping device further comprises a second fastening bolt in threaded engagement with the bent portion, and one end of the second fastening bolt is configured to abut against the lower part of the second component.

7. The clamping device of claim 1, wherein:
one of the two jaws is a fixed jaw and the other of the two jaws is an adjustable jaw, and the adjustable jaw is arranged in a sliding slot extending along the second direction, such that a position of the adjustable jaw in the second direction relative to the fixed jaw is changeable;
the first component comprises a base portion extending along the first direction and a first extension portion extending in the second direction, and the base portion is provided with a slide rail extending along the first direction, and the second component is configured to move along the slide rail;
the clamping device further comprises a first fastening bolt extending along the first direction and having a first part passing through the first extension portion of the first component and a second part passing through the second component, wherein the second part of the first fastening bolt is in threaded engagement with the second component;
the second component has, in the second direction, an upper part located above the slide rail and a lower part located below the slide rail, and the lower part extends below the base portion and abuts against a lower surface of the base portion;
the first component further comprises a second extension portion extending from the base portion toward a direction opposite to an extending direction of the first extension portion, and an end of the second extension portion has a bent portion; and
the clamping device further comprises a second fastening bolt in threaded engagement with the bent portion, and one end of the second fastening bolt is configured to abut against the lower part of the second component.

8. A pickup truck tonneau cover assembly, comprising a tonneau cover and a clamping device for fixing the tonneau cover to a truck bed of a pickup truck,
wherein the truck bed has two side frames respectively located on two sides of the truck bed, and the tonneau cover comprises two mounting frames respectively mounted on the two side frames, and each side frame has a second wall abutting against a first wall of a corresponding one of the two mounting frames;
wherein the clamping device comprises a first component provided with a first jaw and a second component provided with a second jaw, the first component and the second component being configured to move toward or away from each other in a first direction to change a distance between the first jaw and the second jaw to achieve clamping; and
one of the first jaw and the second jaw comprises two jaws spaced apart from each other in a second direction perpendicular to the first direction, and the other of the first jaw and the second jaw is arranged, in the second direction, between the two jaws; and
wherein the first wall and the second wall are clamped and fixed, in the first direction, between the first jaw and the second jaw of the clamping device.

9. The pickup truck tonneau cover assembly of claim 8, wherein one of the two jaws is a fixed jaw and the other of the two jaws is an adjustable jaw, and the adjustable jaw is arranged in a sliding slot extending along the second direction, such that a position of the adjustable jaw in the second direction relative to the fixed jaw is changeable.

10. The pickup truck tonneau cover assembly of claim 8, wherein the first component comprises a base portion extending along the first direction and a first extension portion extending in the second direction, and the base portion is provided with a slide rail extending along the first direction, and the second component is configured to move along the slide rail.

11. The pickup truck tonneau cover assembly of claim 10, wherein the clamping device further comprises a first fastening bolt extending along the first direction and having a first part passing through the first extension portion of the first component and a second part passing through the second component, wherein the second part of the first fastening bolt is in threaded engagement with the second component.

12. The pickup truck tonneau cover assembly of claim 10, wherein the second component has, in the second direction, an upper part located above the slide rail and a lower part located below the slide rail, and the lower part extends below the base portion and abuts against a lower surface of the base portion.

13. The pickup truck tonneau cover assembly of claim 12, wherein:
the first component further comprises a second extension portion extending from the base portion toward a direction opposite to an extending direction of the first extension portion, and an end of the second extension portion has a bent portion; and
the clamping device further comprises a second fastening bolt in threaded engagement with the bent portion, and one end of the second fastening bolt is configured to abut against the lower part of the second component.

14. The pickup truck tonneau cover assembly of claim 8, further comprising a tightening apparatus abutting between the two mounting frames, wherein the tightening apparatus is arranged adjacent to a cab of the pickup truck.

15. The pickup truck tonneau cover assembly of claim 8, further comprising a mounting plate mounted to a front wall of the truck bed or a rear wall of a cab, wherein two ends of the mounting plate are respectively provided with tightening bolts, and one end of each tightening bolt abuts against a corresponding one of the mounting frames.

16. The pickup truck tonneau cover assembly of claim 15, wherein the two ends of the mounting plate are respectively provided with first positioning structures, and an end portion of each mounting frame corresponding to the mounting plate is provided with a second positioning structure corresponding to the first positioning structure.

17. The pickup truck tonneau cover assembly of claim 8, wherein the tonneau cover comprises:
a foldable scissor mechanism arranged in the mounting frame and formed by a plurality of connecting rods connected in sequence;
a plurality of cover plates; and
a plurality of mounting arms, each mounting arm being configured to connect a corresponding one of the plurality of cover plates to a corresponding one of the plurality of connecting rods,
wherein the pickup truck tonneau cover assembly further comprises at least one locking structure configured to lock any one of the plurality of connecting rods, the plurality of mounting arms, and the plurality of cover plates at a predetermined angle or position.

18. The pickup truck tonneau cover assembly of claim 17, wherein the mounting frame is provided therein with a slideway, upper end portions of adjacent connecting rods among the plurality of connecting rods of the scissor mechanism are connected via an upper hinge shaft, and the upper hinge shaft is configured to slide in the slideway.

19. The pickup truck tonneau cover assembly of claim 8, wherein each mounting frame further comprises a horizontal plate-like member at an upper end thereof, and the horizontal plate-like member presses on an upper end surface of the side frame of the truck bed.

20. The pickup truck tonneau cover assembly of claim 8, wherein an upper end of each mounting frame is provided with an inverted U-shaped plate-like member sleeved on an upper end of the side frame.
